(19) United States
(12) Patent Application Publication
(10) Pub. No.: US 2021/0061944 A1
(43) Pub. Date: Mar. 4, 2021

(54) Modified Phenol Polymer and Use Thereof

(71) Applicant: SI Group, Inc., Schenectady, NY (US)

(72) Inventors: Joseph T. Doane, Schenectady, NY (US); Kelly S. Chichak, Halfmoon, NY (US)

(21) Appl. No.: 17/010,928

(22) Filed: Sep. 3, 2020

Related U.S. Application Data
(63) Continuation of application No. 62/895,701, filed on Sep. 4, 2019.

(51) Int. Cl. C08G 61/10; C09K 8/524; C10G 71/00; C10G 75/04

(52) U.S. Cl. CPC C08G 61/10; C09K 8/524; C10G 71/00; C08G 2261/72; C08G 2261/11; C08G 2261/1424; C08G 2261/312; C10G 75/04

(57) ABSTRACT

A polymer, such as for use in a petroleum composition, is provided. The polymer has at least the following repeating unit (I):

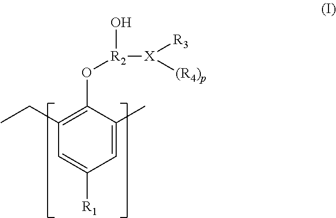

wherein,
R₁ includes an alkyl, an alkenyl, an alkynyl, an aryl, an amine, or -A-Y—R₁₀ wherein
   A is a direct bond or an alkylene;
   Y is —C(O)O—, —OC(O)—, —C(O)N(R₁₁)—, —N(R₁₁)C(O)—, —C(O)—, —N(R₁₁)—, —O—, or —S—;
   R₁₀ includes an alkyl, an alkenyl, an alkynyl, an aryl, or a polyether; and
   R₁₁ is H or an alkyl;
R₂ is an alkylene;
X is —O—, —N—, —O—C(O)—, or —N—C(O)—;
R₃ includes an alkyl, an alkenyl, an alkynyl, or an aryl;
R₄ includes H, an alkyl, an alkenyl, an alkynyl, or an aryl; and
p is 0 when X is —O—, —O—C(O)—, or —N—C(O)— and p is 1 when X is —N—.
   The present invention also provides a method for forming the aforementioned polymer containing the aforementioned repeating unit (I) as well as a method for using the aforementioned polymer containing the aforementioned repeating unit (I).

### RELATED APPLICATIONS

This application claims filing benefit of U.S. Provisional Patent Application No. 62/895,701 having a filing date of Sep. 4, 2019, which is hereby incorporated by reference in its entirety.

### BACKGROUND OF THE INVENTION

Various additives are traditionally employed during oil production to modify the flow properties of a petroleum source or to inhibit the deposition of certain undesirable byproducts onto surfaces. For example, paraffin inhibitors, asphaltene dispersants, and scale inhibitors may be selectively injected into wells or flowlines to treat a petroleum source and prevent or control the effects of precipitation of paraffins, asphaltenes, and mineral scale. These additives can also be used at other points of the oil production cycle, such as during transportation or storage to limit the deposition of solids on the surface of pipes, storage vessels, and transportation vessels (rail cars, ocean tankers, etc.). Unfortunately, because most conventional additives have limited functionality, operators typically need to add multiple different additives to a petroleum source during a production cycle. For example, one additive might be required to disperse or inhibit the crystallization or surface deposition of paraffin waxes, while a completely separate additive might be required to help disperse or inhibit the precipitation of asphaltenes within the petroleum source or deposition of asphaltenes on contacted surfaces. In addition, such conventional additives may also have a limited shelf-life. As such, a need continues to exist for an additive that is capable of exhibiting a broad spectrum of benefits, particularly when added to a petroleum source, and has a relatively longer shelf-life.

### SUMMARY OF THE INVENTION

In accordance with one embodiment of the present invention, a polymer is disclosed having the following repeating unit (I):

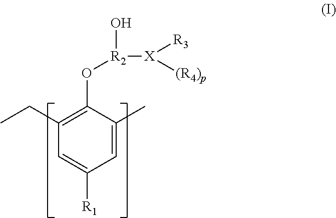

wherein,

R₁ includes an alkyl, an alkenyl, an alkynyl, an aryl, an amine, or A-Y—R₁₀ wherein
A is a direct bond or an alkylene;
Y is —C(O)O—, —OC(O)—, —C(O)N(R₁₁)—, —N(R₁₁)C(O)—, —C(O)—, —N(R₁₁)—, —O—, or —S—;
R₁₀ includes an alkyl, an alkenyl, an alkynyl, an aryl, or a polyether; and
R₁₁ is H or an alkyl;

R₂ is an alkylene;

X is —O—, —N—, —O—C(O)—, or —N—C(O)—;

R₃ includes an alkyl, an alkenyl, an alkynyl, or an aryl;

R₄ includes H, an alkyl, an alkenyl, an alkynyl, or an aryl; and

p is 0 when X is —O—, —O—C(O)—, or —N—C(O)— and p is 1 when X is —N—.

In accordance with another embodiment of the present invention, a method of forming the polymer as described above is disclosed wherein the method comprises reacting a phenol polymer with a compound including a glycidyl group.

In accordance with another embodiment of the present invention, a paraffin inhibitor composition is disclosed comprising the polymer as described above.

In accordance with another embodiment of the present invention, a petroleum composition is disclosed comprising the polymer as described above and a petroleum source.

In accordance with another embodiment of the present invention, a method for modifying a petroleum source is disclosed comprising adding a polymer as described above to a petroleum source.

Other features and aspects of the present invention are set forth in greater detail below.

### Definitions

It is to be understood that the terminology used herein is for the purpose of describing particular embodiments only and is not intended to limit the scope of the present invention.

“Alkyl” refers to straight chain, branched chain, or cyclic monovalent saturated aliphatic hydrocarbyl groups and “C_{q}-Cᵣ alkyl” refers to alkyl groups having from q to r carbon atoms. This term includes, by way of example, straight chain, branched chain, or cyclic hydrocarbyl groups, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, henicosanyl, docosanyl, tricosanyl, tetracosanyl, pentacosanyl, hexacosanyl, heptacosanyl, octacosanyl, and the like. Alkyl includes a substituted alkyl or an unsubstituted alkyl. For example, the alkyl may be substituted (e.g., having from 1 to 5 and, in some embodiments, 1 to 3 or 1 to 2 substituents). Alternatively, the alkyl may be unsubstituted.

“Alkylene” refers to a straight chain or branched chain divalent hydrocarbyl. For example, “C_{q}-Cᵣ alkylene” refers to an alkylene group having from q to r carbon atoms. This term includes, by way of example, straight chain or branched chain hydrocarbyl groups, such as methylene, ethylene, propylene (e.g., n-propylene), butylene (e.g., n-butylene), and the like.

“Alkenyl” refers to a straight chain or branched chain monovalent aliphatic hydrocarbyl group having at least 1 site of vinyl unsaturation (>C═C<). For example, “C_{q}-Cᵣ alkenyl” refers to alkenyl groups having from q to r carbon atoms. This term includes, by way of example, straight chain or branched chain hydrocarbyl groups, such as ethenyl, propenyl, 1,3-butadienyl, and the like. Alkenyl includes a substituted alkenyl or an unsubstituted alkenyl. For example, the alkenyl may be substituted (e.g., having from 1 to 5 and, in some embodiments, 1 to 3 or 1 to 2 substituents). Alternatively, the alkenyl may be unsubstituted.

“Alkynyl” refers to a straight chain or branched chain monovalent aliphatic hydrocarbyl group having at least one carbon triple bond. The term “alkynyl” is also meant to include those hydrocarbyl groups having one triple bond and one double bond. For example, “C_{q}-Cᵣ alkynyl” refers to alkynyl groups having from q to r carbon atoms. This term includes, by way of example, straight chain or branched chain hydrocarbyl groups, such as ethynyl, propynyl, and the like. Alkynyl includes a substituted alkynyl or an unsubstituted alkynyl. For example, the alkynyl may be substituted (e.g., having from 1 to 5 and, in some embodiments, 1 to 3 or 1 to 2 substituents). Alternatively, the alkynyl may be unsubstituted.

“Aryl” refers to an aromatic hydrocarbyl group. For example, “C_{q}-Cᵣ aryl” refers to aryl groups having from q to r carbon atoms. This term includes, by way of example, linear and branched hydrocarbyl groups, such as phenyl, naphthyl, indenyl, azulenyl, fluorenyl, anthracenyl phenanthrenyl, tetrahydronaphthyl, indanyl, phenanthridinyl and the like. Aryl includes a substituted aryl or an unsubstituted aryl. For example, the aryl may be substituted (e.g., having from 1 to 5 and, in some embodiments, 1 to 3 or 1 to 2 substituents). Alternatively, the aryl may be unsubstituted.

It is understood that the above definitions are not intended to include impermissible substitution patterns (e.g., methyl substituted with 5 fluoro groups). Such impermissible substitution patterns are well known to a person skilled in the art.

### BRIEF DESCRIPTION OF THE FIGURES

A full and enabling disclosure of the present invention, including the best mode thereof, directed to one of ordinary skill in the art, is set forth more particularly in the remainder of the specification, which makes reference to the appended figures in which:

FIG. 1 is a graph showing the oscillation displacement as a function of temperature for the butyl glycidyl ether modified polymer of Example 1 at various molar equivalents;

FIG. 2 is a graph showing the oscillation displacement as a function of temperature for the C₁₂-C₁₄ glycidyl ether modified polymer of Example 4 at various molar equivalents;

FIG. 3 is a graph providing a comparison of the oscillation displacement as a function of temperature for the butyl glycidyl ether modified polymer of Example 1 and the C₁₂-C₁₄ glycidyl ether modified polymer of Example 4;

FIG. 4 is a graph showing the oscillation displacement as a function of temperature for the butyl glycidyl ether modified polymer of Example 2 at various molar equivalents;

FIG. 5 is a graph showing the oscillation displacement as a function of temperature for the C₁₂-C₁₄ glycidyl ether modified polymer of Example 5 at various molar equivalents;

FIGS. 6A-6C are graphs showing the oscillation sweeps of Control Polymer 1 of Example 1, the butyl glycidyl ether modified polymer of Example 1, and the C₁₂-C₁₄ glycidyl ether modified polymer of Example 4;

FIG. 7 is a graph showing the oscillation sweeps of the C₁₂-C₁₄ glycidyl ether modified polymer of Example 4 at various molar equivalents; and

FIG. 8 provides a summary of the solvent tolerance as determined according to Example 8.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer formed from a phenol polymer wherein at least a portion of the hydroxyl groups bonded to the aromatic ring have been modified or reacted. The present inventors have discovered that modifying such polymers can result in a broad spectrum of benefits, particularly when used to modify a petroleum source. For instance, such modification may result in an improved shelf life of the polymer and result in an improvement in flow properties. In addition, the polymer may be tailored to provide a wide variety of beneficial properties to a petroleum composition. For example, the polymer may function as a viscosity modifier, a paraffin inhibitor, and/or a pour point depressant, etc. In this regard, the present inventors have also discovered that the polymer can be “multi-functional” in that it exhibits two or more beneficial functions when used with a petroleum source. This can reduce costs and simplify operations as it allows a single material to accomplish multiple functions rather than requiring the use of two or more separate materials.

In this regard, in one embodiment, the polymer may function as a paraffin inhibitor. For instance, when tested according to the Cold Finger method described herein, the composition may achieve a percent paraffinic wax deposition inhibition of about 50% or more, such as about 55% or more, such as about 60% or more, such as about 70% or more, such as about 80% or more to about 100% or less, such as about 99% or less, such as about 97% or less, such as about 95% or less, such as about 93% or less, such as about 90% or less, such as about 85% or less for a given model oil fluid.

Without intending to be limited by theory, the ability of the polymer to function effectively at low temperatures is believed to be at least partially due to its ability to retain good solubility and flow properties at low temperatures. For example, the no-flow point of the polymer may be relatively low, such as about −5° C. or less, such as about −10° C. or less, such as about −20° C. or less, such as about −25° C. or less, such as about −30° C. or less to about −70° C. or more, such as about −60° C. or more, such as about −50° C. or more, such as about −40° C. or more, such as about −30° C. or more, such as about −20° C. or more when determined in accordance with either ASTM D-7346-15 and at a non-volatile residue percentage that may vary from 5% to 30% (e.g., 15%). Furthermore, the modification may allow for an improvement in the no-flow point compared to the unmodified polymer. For instance, the modification may allow for an improvement of 0.05% or more, such as 0.1% or more, such as 0.2% or more, such as 0.5% or more, such as 1% or more, such as 2% or more, such as 3% or more, such as 5% or more, such as 7% or more, such as 10% or more, such as 20% or more, such as 30% or more in the no flow point of the polymer compared to the no flow point of an unmodified polymer. Such improvement in the no flow point of the polymer may be 90% or less, such as 80% or less, such as 70% or less, such as 60% or less, such as 50% or less, such as 40% or less, such as 30% or less, such as 25% or less, such as 20% or less, such as 15% or less, such as 10% or less, such as 8% or less, such as 6% or less, such as 5% or less, such as 3% or less compared to the no flow point of an unmodified polymer. However, in some instances, an improvement in the no flow point may not be realized. In this regard, the no flow point may be substantially similar or may even decrease slightly. For instance, with polymers that generally already exhibit a relatively low no flow point, an improvement may not be realized by the modification. As an example and without intending to be limited, polymers having a no flow point of less than −10° C., such as less than −15° C. may not exhibit an improvement in the no flow point as a result of the modification.

The aforementioned percent paraffinic wax deposition inhibition and/or no-flow point may also be realized by a composition, such as a paraffin inhibitor composition. In addition to simply performing well at low temperatures, good properties can be maintained at a cold temperature site without risking gel formation over a broad range of temperatures.

The polymer may also exhibit further beneficial properties indicative of improved performance at low temperatures. For instance, the polymer may also exhibit a reduced pour point thereby indicating a reduction in the temperature at which point the flow characteristics generally diminish. For instance, with the polymer as disclosed herein, the pour point depression (ΔPP) may be at least 1° C., such as at least 3° C., such as at least 5° C., such as at least 8° C., such as at least 10° C., such as at least 20° C., such as at least 30° C., such as at least 50° C., such as at least 60° C., such as at least 65° C., such as at least 70° C. when determined in accordance with ASTM D-5949. The pour point depression (ΔPP) may be 100° C. or less, such as 90° C. or less, such as 80° C. or less, such as 75° C. or less, such as 70° C. or less, such as 60° C. or less, such as 50° C. or less when determined in accordance with ASTM D-5949. Such depression may be realized at least at a polymer dosage of 2000 ppm, 1000 ppm, 500 ppm, and/or 250 ppm.

Also, the polymer may allow for a reduction in the cloud point temperature thereby indicating a reduction in the temperature at which point a sample becomes relatively cloudy and begins to solidify. In this regard, with the polymer as disclosed herein, the cloud point depression (ΔCP) may be at least 0.5° C., such as at least 1° C., such as at least 1.5° C., such as at least 2° C., such as at least 2.5° C., such as at least 3° C., such as at least 3.5° C., such as at least 4° C. when determined in accordance with ASTM D-5773. The cloud point depression (ΔCP) may be 5° C. or less, such as 4.5° C. or less, such as 4° C. or less, such as 3.5° C. or less, such as 3° C. or less, such as 2.5° C. or less, such as 2° C. or less, such as 1° C. or less when determined in accordance with ASTM D-5773. Such depression may be realized at least at a polymer dosage of 2000 ppm, 1000 ppm, 500 ppm, and/or 250 ppm.

The polymer of the present invention generally has the following repeating unit (I):

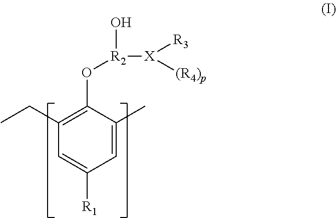

wherein,

R₁ includes an alkyl, an alkenyl, an alkynyl, an aryl, an amine, or -A-Y—R₁₀ wherein
A is a direct bond or an alkylene;
Y is —C(O)O—, —OC(O)—, —C(O)N(R₁₁)—, —N(R₁₁)C(O)—, —C(O)—, —N(R¹¹)—, —O—, or —S—;
R₁₀ includes an alkyl, an alkenyl, an alkynyl, an aryl, or a polyether; and
R₁₁ is H or an alkyl;

R₂ is an alkylene;

X is —O—, —N—, —O—C(O)—, or —N—C(O)—;

R₃ includes an alkyl, an alkenyl, an alkynyl, or an aryl;

R₄ includes H, an alkyl, an alkenyl, an alkynyl, or an aryl; and

p is 0 when X is —O—, —O—C(O)—, or —N—C(O)— and p is 1 when X is —N—.

As indicated above, R₁ includes an alkyl, an alkenyl, an alkynyl, an aryl, an amine, or -A-Y—R₁₀. For instance, in one embodiment, R₁ may include an alkyl, an alkenyl, an alkynyl, or -A-Y—R₁₀. In particular, R₁ may include a C₁-C₈₀ alkyl, a C₂-C₈₀ alkenyl, a C₂-C₈₀ alkynyl, a C₃-C₁₂ aryl, or -A-Y—R₁₀. In one particular embodiment, R₁ includes an alkyl. In another embodiment, R₁ includes an alkenyl. In a further embodiment, R₁ includes an alkynyl. In another embodiment, R₁ includes an aryl. In a further embodiment, R₁ includes an amine. In a further embodiment, R₁ includes -A-Y—R₁₀. In one embodiment, R₁ includes an alkyl or -A-Y—R₁₀.

As indicated above, in one embodiment, R₁ may include an alkyl. For instance, the alkyl may be a C₁-C₈₀ alkyl. In this regard, the R₁ alkyl may be a C₁-C₈₀ alkyl, such as a C₃-C₈₀ alkyl, such as a C₄-C₇₀ alkyl, such as a C₅-C₆₀ alkyl, such as a C₆-C₅₀ alkyl, such as a C₈-C₄₀ alkyl, such as a C₁₀-C₃₀ alkyl, such as a C₁₂-C₂₆ alkyl, such as a C₁₄-C₂₄ alkyl, such as a C₁₆-C₂₂ alkyl. In addition, the R₁ alkyl may be a C₁-C₈₀ alkyl, such as a C₁₀-C₈₀ alkyl, such as a C₂₀-C₈₀ alkyl, such as a C₃₀-C₈₀ alkyl. For instance, the R₁ alkyl may have 1 or more, such as 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₁ alkyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₁ alkyl may be a straight chain, a branched chain, or cyclic. In one embodiment, the R₁ alkyl is a straight chain. In another embodiment, the R₁ alkyl is a branched chain. In a further embodiment, the R₁ alkyl is cyclic.

As indicated above, in one embodiment, R₁ may include an alkenyl. For instance, the R₁ alkenyl may be a C₂-C₈₀ alkenyl. In this regard, the R₁ alkenyl may be a C₂-C₈₀ alkenyl, such as a C₃-C₈₀ alkenyl, such as a C₄-C₇₀ alkenyl, such as a C₅-C₆₀ alkenyl, such as a C₆-C₅₀ alkenyl, such as a C₈-C₄₀ alkenyl, such as a C₁₀-C₃₀ alkenyl, such as a C₁₂-C₂₆ alkenyl, such as a C₁₄-C₂₄ alkenyl, such as a C₁₆-C₂₂ alkenyl. In addition, the R₁ alkenyl may be a C₂-C₈₀ alkenyl, such as a C₁₀-C₈₀ alkenyl, such as a C₂₀-C₈₀ alkenyl, such as a C₃₀-C₈₀ alkenyl. For instance, the R₁ alkenyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₁ alkenyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₁ alkenyl may be a straight chain or a branched chain. In one embodiment, the R₁ alkenyl is a straight chain. In another embodiment, the R₁ alkenyl is a branched chain.

As indicated above, in one embodiment, R₁ may include an alkynyl. For instance, the R₁ alkynyl may be a C₂-C₈₀ alkynyl. In this regard, the R₁ alkynyl may be a C₂-C₈₀ alkynyl, such as a C₃-C₈₀ alkynyl, such as a C₄-C₇₀ alkynyl, such as a C₅-C₆₀ alkynyl, such as a C₆-C₅₀ alkynyl, such as a C₈-C₄₀ alkynyl, such as a C₁₀-C₃₀ alkynyl, such as a C₁₂-C₂₆ alkynyl, such as a C₁₄-C₂₄ alkynyl, such as a C₁₆-C₂₂ alkynyl. In addition, the R₁ alkynyl may be a C₂-C₈₀ alkynyl, such as a C₁₀-C₈₀ alkynyl, such as a C₂₀-C₈₀ alkynyl, such as a C₃₀-C₈₀ alkynyl. For instance, the R₁ alkynyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₁ alkynyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₁ alkynyl may be a straight chain or a branched chain. In one embodiment, the R₁ alkynyl is a straight chain. In another embodiment, the R₁ alkynyl is a branched chain.

As indicated above, in one embodiment, R₁ may include an aryl. For instance, the R₁ aryl may be a C₃-C₁₂ aryl. In this regard, the R₁ aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the R₁ aryl may have 3 or more, such as 4 or more, such as 5 or more, such as 6 or more carbon atoms. The R₁ aryl may have 12 or less, such as 10 or less, such as 8 or less, such as 7 or less, such as 6 or less, such as 5 or less carbon atoms. In addition, in one embodiment, the R₁ aryl may be polycyclic. The polycyclic aryl may include fused, bridged, and spiro ring systems.

As indicated above, in one embodiment, R₁ may include -A-Y—R₁₀ wherein A is a direct bond or an alkylene; Y is —C(O)O—, —OC(O)—, —C(O)N(R₁₁)—, —N(R₁₁)C(O)—, —C(O)—, —N(R₁₁)—, —O—, or —S—; R₁₀ includes an alkyl, an alkenyl, an alkynyl, an aryl, or a polyether; and R₁₁ is H or an alkyl.

As indicated above, “A” is a direct bond or an alkylene. In one embodiment, “A” is a direct bond such that the carbon in the ring is bonded directly to “Y.” In another embodiment, “A” is an alkylene (i.e., an alkylene bridge) bonded to the carbon in the ring and “Y.” For instance, the alkylene may be a C₁-C₈ alkylene, such as a C₁-C₅ alkylene, such as a C₁-C₃ alkylene, such as a C₁-C₂ alkylene or a C₂-C₃ alkylene. For instance, the alkylene may be a methylene, an ethylene, a propylene, a butylene, etc. In one embodiment, the alkylene may be a methylene. In another embodiment, the alkylene may be an ethylene. In a further embodiment, the alkylene may be a propylene. In an even further embodiment, the alkylene may be a butylene. The alkylene may have 1 or more, such as 2 or more, such as 3 or more, such as 4 or more carbon atoms. The alkylene may have 8 or less, such as 7 or less, such as 6 or less, such as 5 or less, such as 4 or less, such as 3 or less carbon atoms. Also, it should be understood that, in one embodiment, the alkylene may be a substituted alkylene wherein the substitution may comprise a C₁-C₂₀ alkyl, such as a C₁-C₁₅ alkyl, such as a C₁-C₁₀ alkyl, such as a C₁-C₈ alkyl, such as a C₁-C₄ alkyl.

As indicated above, “Y” is —C(O)O—, —OC(O)—, —C(O)N(R₁₁)—, —N(R₁₁)C(O)—, —C(O)—, —N(R₁₁)—, —O—, or —S—. For instance, “Y” may be —C(O)O—, —OC(O)—, —C(O)N(R₁₁)—, —N(R₁₁)C(O)—, or —C(O)—. In particular, “Y” may be —C(O)O— or —OC(O)—. In this regard, in one embodiment, “Y” is —C(O)O—. In another embodiment, “Y” is —OC(O)—. In a further embodiment, “Y” is —C(O)N(R₁₁)—. In an even further embodiment, “Y” is —N(R₁₁)C(O)—. In another embodiment, “Y” is —C(O)—. In a further embodiment, “X” is —O—. In one embodiment, “Y” is —S—.

As indicated above, in one embodiment, “Y” may be —C(O)N(R₁₁)—, —N(R₁₁)C(O)—, or —N(R₁₁)—. In this regard, as also indicated above, R₁₁ is H or an alkyl. In one embodiment, R₁₁ is H. In another embodiment, R₁₁ is an alkyl. For instance, the R₁₁ alkyl may be a C₁-C₃₀ alkyl, such as a C₁-C₂₆ alkyl, such as a C₁-C₂₀ alkyl, such as a C₁-C₁₄ alkyl, such as a C₁-C₁₀ alkyl, such as a C₁-C₄ alkyl, such as a C₁-C₃ alkyl, such as a C₁-C₂ alkyl. For instance, the R₁₁ alkyl may have 1 or more, such as 2 or more, such as 3 or more, such as 5 or more, such as 10 or more carbon atoms. The R₁₁ alkyl may have 30 or less, such as 24 or less, such as 20 or less, such as 18 or less, such as 12 or less, such as 8 or less, such as 6 or less, such as 4 or less, such as 3 or less, such as 2 or less carbon atoms. In addition, the R₁₁ alkyl may be a straight chain, a branched chain, or cyclic. In one embodiment, the R₁₁ alkyl is a straight chain. In another embodiment, the R₁₁ alkyl is a branched chain. In a further embodiment, the R₁₁ alkyl is cyclic.

As indicated above, R₁₀ includes an alkyl, an alkenyl, an alkynyl, an aryl, or a polyether. For instance, R₁₀ may include a C₁-C₈₀ alkyl, a C₂-C₈₀ alkenyl, a C₂-C₈₀ alkynyl, a C₃-C₁₂ aryl, or a polyether. For instance, in one embodiment, R₁₀ may include an alkyl, an alkenyl, or a polyether. In another embodiment, R₁₀ may include an alkyl or a polyether. In one embodiment, R₁₀ may include an alkyl. In another embodiment, R₁₀ may include an alkenyl. In a further embodiment, R₁₀ may include an alkynyl. In another further embodiment, R₁₀ may include a polyether.

As indicated above, in one embodiment, R₁₀ may include a C₁-C₈₀ alkyl. In this regard, the R₁₀ alkyl may be a C₁-C₈₀ alkyl, such as a C₃-C₈₀ alkyl, such as a C₄-C₇₀ alkyl, such as a C₅-C₆₀ alkyl, such as a C₆-C₅₀ alkyl, such as a C₈-C₄₀ alkyl, such as a C₁₀-C₃₀ alkyl, such as a C₁₂-C₂₆ alkyl, such as a C₁₄-C₂₄ alkyl, such as a C₁₆-C₂₂ alkyl. In addition, the R₁₀ alkyl may be a C₁-C₈₀ alkyl, such as a C₁₀-C₈₀ alkyl, such as a C₂₀-C₈₀ alkyl, such as a C₃₀-C₈₀ alkyl. For instance, the R₁₀ alkyl may have 1 or more, such as 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₁₀ alkyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₁₀ alkyl may be a straight chain, a branched chain, or cyclic. In one embodiment, the R₁₀ alkyl is a straight chain. In another embodiment, the R₁₀ alkyl is a branched chain. In a further embodiment, the R₁₀ alkyl is cyclic.

As indicated above, in one embodiment, R₁₀ may be a branched chain alkyl. In this regard, the R₁₀ alkyl may be provided by reacting a Guerbet alcohol with the monomer precursor (i.e., the dialkyphenol or the deprotected dialkyphenol). As generally known in the art, Guerbet alcohols are saturated primary alcohols with branching of the carbon chain. In this regard, such alcohols may be described as 2-alkyl-1-alkanols. Without being limited, these alcohols may yield 2-butyl hexyl, 2-butyl octyl, 2-butyl decyl, 2-butyl dodecyl, 2-butyl tetradecyl, 2-butyl hexadecyl, 2-butyl octadecyl, 2-hexyl octyl, 2-hexyl decyl, 2-hexyl dodecyl, 2-hexyl tetradecyl, 2-hexyl hexadecyl, 2-hexyl octadecyl, 2-octyl hexyl, 2-octyl decyl, 2-octyl dodecyl, 2-octyl tetradecyl, 2-octyl hexadecyl, 2-octyl octadecyl, 2-decyl hexyl, 2-decyl octyl, 2-decyl dodecyl, 2-decyl tetradecyl, 2-decyl hexadecyl, 2-decyl octadecyl, 2-dodecyl hexyl, 2-dodecyl octyl, 2-dodecyl decyl, 2-dodecyl tetradecyl, 2-dodecyl hexadecyl, 2-dodecyl octadecyl, 2-tetradecyl hexyl, 2-tetradecyl octyl, 2-tetradecyl decyl, 2-tetradecyl dodecyl, 2-tetradecyl hexadecyl, and 2-tetradecyl octadecyl.

As indicated above, in one embodiment, R₁₀ may include an alkenyl. For instance, the R₁₀ alkenyl may be a C₂-C₈₀ alkenyl. In this regard, the R₁₀ alkenyl may be a C₂-C₈₀ alkenyl, such as a C₃-C₈₀ alkenyl, such as a C₄-C₇₀ alkenyl, such as a C₅-C₆₀ alkenyl, such as a C₆-C₅₀ alkenyl, such as a C₈-C₄₀ alkenyl, such as a C₁₀-C₃₀ alkenyl, such as a C₁₂-C₂₆ alkenyl, such as a C₁₄-C₂₄ alkenyl, such as a C₁₆-C₂₂ alkenyl. In addition, the R₁₀ alkenyl may be a C₂-C₈₀ alkenyl, such as a C₁₀-C₈₀ alkenyl, such as a C₂₀-C₈₀ alkenyl, such as a C₃₀-C₈₀ alkenyl. For instance, the R₁₀ alkenyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₁₀ alkenyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₁₀ alkenyl may be a straight chain or a branched chain. In one embodiment, the R₁₀ alkenyl is a straight chain. In another embodiment, the R₁₀ alkenyl is a branched chain.

As indicated above, in one embodiment, R₁₀ may include an alkynyl. For instance, the R₁₀ alkynyl may be a C₂-C₈₀ alkynyl. In this regard, the R₁₀ alkynyl may be a C₂-C₈₀ alkynyl, such as a C₃-C₈₀ alkynyl, such as a C₄-C₇₀ alkynyl, such as a C₅-C₆₀ alkynyl, such as a C₆-C₅₀ alkynyl, such as a C₈-C₄₀ alkynyl, such as a C₁₀-C₃₀ alkynyl, such as a C₁₂-C₂₆ alkynyl, such as a C₁₄-C₂₄ alkynyl, such as a C₁₆-C₂₂ alkynyl. In addition, the R₁₀ alkynyl may be a C₂-C₈₀ alkynyl, such as a C₁₀-C₈₀ alkynyl, such as a C₂₀-C₈₀ alkynyl, such as a C₃₀-C₈₀ alkynyl. For instance, the R₁₀ alkynyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₁₀ alkynyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₁₀ alkynyl may be a straight chain or a branched chain. In one embodiment, the R₁₀ alkynyl is a straight chain. In another embodiment, the R₁₀ alkynyl is a branched chain.

As indicated above, in one embodiment, R₁₀ may include a C₃-C₁₂ aryl. In this regard, the R₁₀ aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the R₁₀ aryl may have 3 or more, such as 4 or more, such as 5 or more, such as 6 or more carbon atoms. The R₁₀ aryl may have 12 or less, such as 10 or less, such as 8 or less, such as 7 or less, such as 6 or less, such as 5 or less carbon atoms. In addition, in one embodiment, the R₁₀ aryl may be polycyclic. The polycyclic aryl may include fused, bridged, and spiro ring systems.

As indicated above, in one embodiment, R₁₀ may include a polyether. As generally known in the art, such polyethers are compounds having at least one ether group. In this regard, the R₁₀ polyether may be a C₂ polyether, a C₃ polyether, or a C₄ polyether. For instance, in one embodiment, the polyether may be a polyethylene glycol. In another embodiment, the polyether may be a polypropylene glycol. In an even further embodiment, the polyether may be a polytetramethylene glycol. The polyether may have a weight average molecular weight of 200 g/mol or more, such as 300 g/mol or more, such as 400 g/mol or more, such as 500 g/mol, such as 750 g/mol or more, such as 1,000 g/mol or more to 10,000 g/mol or less, such as 7,500 g/mol or less, such as 5,000 g/mol or less, such as 4,000 g/mol or less, such as 3,000 g/mol or less, such as 2,500 g/mol or less, such as 2,000 g/mol or less, such as 1,500 g/mol or less, such as 1,250 g/mol or less, such as 1,000 g/mol or less.

As indicated above, R₂ is an alkylene (i.e., an alkylene bridge) bonded to the adjacent oxygen and “X.” For instance, the alkylene may be a C₁-C₈ alkylene, such as a C₁-C₆ alkylene, such as a C₂-C₆ alkylene, such as a C₂-C₅ alkylene, such as a C₂-C₄ alkylene. For instance, the alkylene may be a methylene, an ethylene, a propylene, a butylene, etc. In one embodiment, the alkylene may be a methylene. In another embodiment, the alkylene may be an ethylene. In a further embodiment, the alkylene may be a propylene. In an even further embodiment, the alkylene may be a butylene. The alkylene may have 1 or more, such as 2 or more, such as 3 or more, such as 4 or more carbon atoms. The alkylene may have 8 or less, such as 7 or less, such as 6 or less, such as 5 or less, such as 4 or less, such as 3 or less carbon atoms.

As indicated above, “X” is —O—, —N—, —O—C(O)—, or —N—C(O)—. For instance, in one embodiment, “X” may be —O—, —N—, or —O—C(O)—. In another embodiment, “X” may be —O— or —O—C(O)—. For instance, in one embodiment, “X” may be —O—. In a further embodiment, “X” may be —N—. In another embodiment, “X” may be —O—C(O)—. In an even further embodiment, “X” may be —N—C(O)—.

As indicated above, R₃ includes an alkyl, an alkenyl, an alkynyl, or an aryl. For instance, in one embodiment, R₃ may include an alkyl, an alkenyl, or an alkynyl. In particular, R₃ may include a C₁-C₈₀ alkyl, a C₂-C₈₀ alkenyl, a C₂-C₈₀ alkynyl, or a C₃-C₁₂ aryl. In one particular embodiment, R₃ includes an alkyl. In another embodiment, R₃ includes an alkenyl. In a further embodiment, R₃ includes an alkynyl. In another embodiment, R₃ includes an aryl.

As indicated above, in one embodiment, R₃ may include an alkyl. For instance, the alkyl may be a C₁-C₈₀ alkyl. In this regard, the R₃ alkyl may be a C₁-C₈₀ alkyl, such as a C₃-C₈₀ alkyl, such as a C₄-C₇₀ alkyl, such as a C₅-C₆₀ alkyl, such as a C₆-C₅₀ alkyl, such as a C₈-C₄₀ alkyl, such as a C₁₀-C₃₀ alkyl, such as a C₁₂-C₂₆ alkyl, such as a C₁₄-C₂₄ alkyl, such as a C₁₆-C₂₂ alkyl. In addition, the R₃ alkyl may be a C₁-C₈₀ alkyl, such as a C₁₀-C₈₀ alkyl, such as a C₂₀-C₈₀ alkyl, such as a C₃₀-C₈₀ alkyl. However, the R₃ alkyl may also be a shorter chain alkyl such as a C₁-C₂₀ alkyl, such as a C₁-C₁₆ alkyl, such as a C₁-C₁₂ alkyl, such as a C₁-C₁₀ alkyl, such as a C₁-C₈ alkyl, such as a C₂-C₈ alkyl, such as a C₂-C₈ alkyl, such as a C₂-C₅ alkyl, such as a C₃-C₅ alkyl. The R₃ alkyl may have 1 or more, such as 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₃ alkyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₃ alkyl may be a straight chain, a branched chain, or cyclic. In one embodiment, the R₃ alkyl is a straight chain. In another embodiment, the R₃ alkyl is a branched chain. In a further embodiment, the R₃ alkyl is cyclic.

As indicated above, in one embodiment, R₃ may include an alkenyl. For instance, the R₃ alkenyl may be a C₂-C₈₀ alkenyl. In this regard, the R₃ alkenyl may be a C₂-C₈₀ alkenyl, such as a C₃-C₈₀ alkenyl, such as a C₄-C₇₀ alkenyl, such as a C₅-C₆₀ alkenyl, such as a C₆-C₅₀ alkenyl, such as a C₈-C₄₀ alkenyl, such as a C₁₀-C₃₀ alkenyl, such as a C₁₂-C₂₆ alkenyl, such as a C₁₄-C₂₄ alkenyl, such as a C₁₆-C₂₂ alkenyl. In addition, the R₃ alkenyl may be a C₂-C₈₀ alkenyl, such as a C₁₀-C₈₀ alkenyl, such as a C₂₀-C₈₀ alkenyl, such as a C₃₀-C₈₀ alkenyl. However, the R₃ alkenyl may also be a shorter chain alkenyl such as a C₂-C₂₀ alkenyl, such as a C₂-C₁₆ alkenyl, such as a C₂-C₁₂ alkenyl, such as a C₂-C₁₀ alkenyl, such as a C₂-C₈ alkenyl, such as a C₂-C₆ alkenyl. The R₃ alkenyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₃ alkenyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₃ alkenyl may be a straight chain or a branched chain. In one embodiment, the R₃ alkenyl is a straight chain. In another embodiment, the R₃ alkenyl is a branched chain.

As indicated above, in one embodiment, R₃ may include an alkynyl. For instance, the R₃ alkynyl may be a C₂-C₈₀ alkynyl. In this regard, the R₃ alkynyl may be a C₂-C₈₀ alkynyl, such as a C₃-C₈₀ alkynyl, such as a C₄-C₇₀ alkynyl, such as a C₅-C₆₀ alkynyl, such as a C₆-C₅₀ alkynyl, such as a C₈-C₄₀ alkynyl, such as a C₁₀-C₃₀ alkynyl, such as a C₁₂-C₂₆ alkynyl, such as a C₁₄-C₂₄ alkynyl, such as a C₁₆-C₂₂ alkynyl. In addition, the R₃ alkynyl may be a C₂-C₈₀ alkynyl, such as a C₁₀-C₈₀ alkynyl, such as a C₂₀-C₈₀ alkynyl, such as a C₃₀-C₈₀ alkynyl. However, the R₃ alkynyl may also be a shorter chain alkynyl such as a C₂-C₂₀ alkynyl, such as a C₂-C₁₆ alkynyl, such as a C₂-C₁₂ alkynyl, such as a C₂-C₁₀ alkynyl, such as a C₂-C₈ alkynyl, such as a C₂-C₆ alkynyl. The R₃ alkynyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₃ alkynyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the R₃ alkynyl may be a straight chain or a branched chain. In one embodiment, the R₃ alkynyl is a straight chain. In another embodiment, the R₃ alkynyl is a branched chain.

As indicated above, in one embodiment, R₃ may include an aryl. For instance, the R₃ aryl may be a C₃-C₁₂ aryl. In this regard, the R₃ aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the R₃ aryl may have 3 or more, such as 4 or more, such as 5 or more, such as 6 or more carbon atoms. The R₃ aryl may have 12 or less, such as 10 or less, such as 8 or less, such as 7 or less, such as 6 or less, such as 5 or less carbon atoms. In addition, in one embodiment, the R₃ aryl may be polycyclic. The polycyclic aryl may include fused, bridged, and spiro ring systems.

As indicated above, R₄ includes H, an alkyl, an alkenyl, an alkynyl, or an aryl. For instance, in one embodiment, R₄ may include H, an alkyl, an alkenyl, or an alkynyl. In another embodiment, R₄ may include H or an alkyl. In particular, R₄ may include H, a C₁-C₈₀ alkyl, a C₂-C₈₀ alkenyl, a C₂-C₈₀ alkynyl, or a C₃-C₁₂ aryl. In particular, the alkyl, alkenyl, and alkynyl may be any as defined herein. In one embodiment, R₄ includes H. In another embodiment, R₄ includes an alkyl. In a further embodiment, R₄ includes an alkenyl. In a further embodiment, R₄ includes an alkynyl. In another embodiment, R₄ includes an aryl.

As indicated above, “p” is 0 or 1. In one embodiment, “p” is 0. For instance, when “X” is —O—, —O—C(O)—, or —N—C(O)—, “p” is 0. In another embodiment, “p” is 1. For instance, when “X” is —N—, “p” is 1.

In one embodiment, the repeating unit (I) may be a combination of the following repeating units (II) and (III):

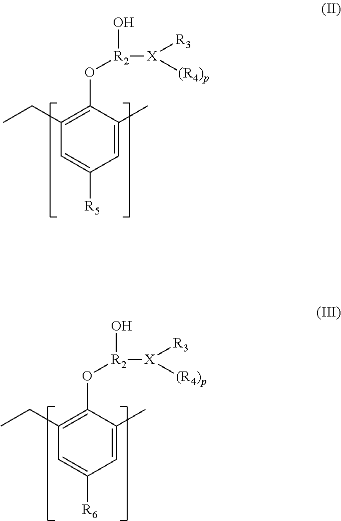

wherein:

R₅ includes a C₁-C₁₅ alkyl;

R₆ includes a C₂-C₈₀ alkyl, wherein R₅ and R₆ are different; and

R₂, X, R₃, R₄, and p are as defined above.

As indicated above, R₅ includes a C₁-C₁₅ alkyl. In this regard, the R₅ alkyl may be a C₁-C₁₅ alkyl, such as a C₁-C₁₄ alkyl, such as a C₂-C₁₄ alkyl, such as a C₆-C₁₄ alkyl, such as a C₈-C₁₄ alkyl, such as a C₁₀-C₁₄ alkyl. For instance, the R₅ alkyl may have 1 or more, such as 2 or more, such as 3 or more, such as 4 or more, such as 5 or more, such as 6 or more, such as 8 or more, such as 10 or more, such as 11 or more, such as 12 or more carbon atoms. The R₅ alkyl may have 15 or less, such as 14 or less, such as 12 or less, such as 10 or less, such as 8 or less, such as 6 or less, such as 4 or less carbon atoms. In addition, the alkyl may be a straight chain, a branched chain, or cyclic. In one embodiment, the alkyl is a straight chain. In another embodiment, the alkyl is a branched chain. In a further embodiment, the alkyl is cyclic.

As indicated above, R₆ includes a C₂-C₈₀ alkyl. In this regard, the R₆ alkyl may be a C₂-C₈₀ alkyl, such as a C₃-C₈₀ alkyl, such as a C₄-C₇₀ alkyl, such as a C₅-C₆₀ alkyl, such as a C₆-C₅₀ alkyl, such as a C₈-C₄₀ alkyl, such as a C₁₀-C₃₀ alkyl, such as a C₁₂-C₂₆ alkyl, such as a C₁₄-C₂₄ alkyl, such as a C₁₆-C₂₂ alkyl. In addition, the R₆ alkyl may be a C₂-C₈₀ alkyl, such as a C₁₀-C₈₀ alkyl, such as a C₂₀-C₈₀ alkyl, such as a C₃₀-C₈₀ alkyl. For instance, the R₆ alkyl may have 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The R₆ alkyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. Regardless, the R₅ alkyl and the R₆ alkyl are different. In addition, the R₆ alkyl may be a straight chain, a branched chain, or cyclic. In one embodiment, the R₆ alkyl is a straight chain. In another embodiment, the R₆ alkyl is a branched chain. In a further embodiment, the R₆ alkyl is cyclic.

When repeating unit (I) is present in a combination of repeating units (II) and (III), they may be present in certain amounts. For instance, the number of units of repeating unit (II) in the polymer may be from 1 to 250. In this regard, the number of units of repeating unit (II) may be 1 or more, such as 2 or more, such as 3 or more, such as 5 or more, such as 10 or more, such as 20 or more, such as 25 or more, such as 30 or more, such as 40 or more, such as 50 or more, such as 75 or more. In addition, the number of units of repeating unit (II) may be 250 or less, such as 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less, such as 20 or less.

In addition, the number of units of repeating unit (III) in the polymer may be from 1 to 250. In this regard, the number of units of repeating unit (III) may be 1 or more, such as 2 or more, such as 3 or more, such as 5 or more, such as 10 or more, such as 20 or more, such as 25 or more, such as 30 or more, such as 40 or more, such as 50 or more, such as 75 or more. In addition, the number of units of repeating unit (III) may be 250 or less, such as 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less, such as 20 or less.

Furthermore, the repeating unit (II) of the polymer may constitute at least 10%, such as at least 20%, such as at least 25%, such as at least 30%, such as at least 40%, such as at least 50%, such as at least 60% to 95% or less, such as 90% or less, such as 80% or less, such as 75% or less, such as 70% or less, such as 65% or less, such as 60% or less, such as 50% or less, such as 40% or less, such as 30% or less, such as 20% or less of the repeating units (I) (i.e., based on the total repeating units (II) and (III)). Likewise, the repeating unit (III) of the polymer may constitute at least 10%, such as at least 20%, such as at least 25%, such as at least 30%, such as at least 40%, such as at least 50%, such as at least 60% to 95% or less, such as 90% or less, such as 80% or less, such as 75% or less, such as 70% or less, such as 65% or less, such as 60% or less, such as 50% or less, such as 40% or less, such as 30% or less, such as 20% or less of the repeating units (I) (i.e., based on the total repeating units (II) and (III)).

In this regard, the ratio of the moles of repeating unit (II) to the moles of repeating unit (III) may typically be controlled within a certain range. For instance, the ratio may be 0.001 or more, such as 0.01 or more, such as 0.05 or more, such as 0.1 or more, such as 0.2 or more, such as 0.5 or more, such as 0.6 or more, such as 0.8 or more to 10 or less, such as 8 or less, such as 5 or less, such as 4 or less, such as 3 or less, such as 2.5 or less, such as 2 or less, such as 1.7 or less, such as 1.5 or less, such as 1.4 or less, such as 1.2 or less, such as 1 or less.

The number average molecular weight of the repeating unit (II) may be about 300 Daltons or more, such as about 500 Daltons or more, such as about 1,000 Daltons or more, such as about 2,000 Daltons or more, such as about 4,000 Daltons or more. The number average molecular weight of the repeating unit (II) may be about 50,000 Daltons or less, such as about 30,000 Daltons or less, such as 20,000 Daltons or less, such as about 15,000 Daltons or less, such as about 12,000 Daltons or less, such as about 10,000 Daltons or less, such as about 8,000 Daltons or less, such as about 6,000 Daltons or less, such as about 4,000 Daltons or less. The number average molecular weight of the repeating unit (III) may likewise be about 300 Daltons or more, such as about 500 Daltons or more, such as about 1,000 Daltons or more, such as about 2,000 Daltons or more, such as about 4,000 Daltons or more. The number average molecular weight of the repeating unit (III) may be about 50,000 Daltons or less, such as about 30,000 Daltons or less, such as 20,000 Daltons or less, such as about 15,000 Daltons or less, such as about 12,000 Daltons or less, such as about 10,000 Daltons or less, such as about 8,000 Daltons or less, such as about 6,000 Daltons or less, such as about 4,000 Daltons or less. The molecular weight may be determined using gel permeation chromatography as generally known in the art.

In one embodiment, the polymer includes a combination of repeating unit (I) and the following repeating unit (IV):

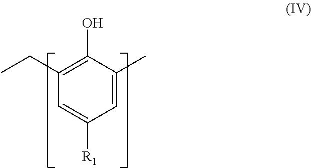

wherein,

R₁ is as defined above.

In one particular embodiment, the repeating unit (IV) may be a combination of the following repeating units (V) and (VI):

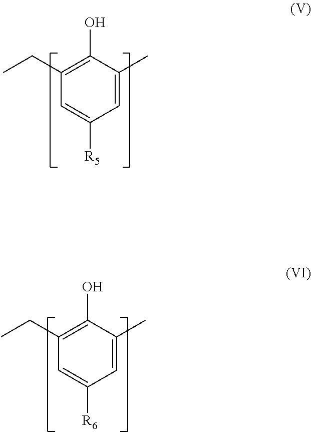

wherein:

R₅ and R₆ are as defined above and are different.

When repeating unit (IV) is present in a combination of repeating units (V) and (VI), they may be present in certain amounts. For instance, the number of units of repeating unit (V) in the polymer may be from 1 to 250. In this regard, the number of units of repeating unit (V) may be 1 or more, such as 2 or more, such as 3 or more, such as 5 or more, such as 10 or more, such as 20 or more, such as 25 or more, such as 30 or more, such as 40 or more, such as 50 or more, such as 75 or more. In addition, the number of units of repeating unit (V) may be 250 or less, such as 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less, such as 20 or less.

In addition, the number of units of repeating unit (VI) in the polymer may be from 1 to 250. In this regard, the number of units of repeating unit (VI) may be 1 or more, such as 2 or more, such as 3 or more, such as 5 or more, such as 10 or more, such as 20 or more, such as 25 or more, such as 30 or more, such as 40 or more, such as 50 or more, such as 75 or more. In addition, the number of units of repeating unit (VI) may be 250 or less, such as 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less, such as 20 or less.

Furthermore, the repeating unit (V) of the polymer may constitute at least 10%, such as at least 20%, such as at least 25%, such as at least 30%, such as at least 40%, such as at least 50%, such as at least 60% to 95% or less, such as 90% or less, such as 80% or less, such as 75% or less, such as 70% or less, such as 65% or less, such as 60% or less, such as 50% or less, such as 40% or less, such as 30% or less, such as 20% or less of the repeating units (IV) (i.e., based on the total repeating units (V) and (VI)). Likewise, the repeating unit (VI) of the polymer may constitute at least 10%, such as at least 20%, such as at least 25%, such as at least 30%, such as at least 40%, such as at least 50%, such as at least 60% to 95% or less, such as 90% or less, such as 80% or less, such as 75% or less, such as 70% or less, such as 65% or less, such as 60% or less, such as 50% or less, such as 40% or less, such as 30% or less, such as 20% or less of the repeating units (IV) (i.e., based on the total repeating units (V) and (VI)).

In this regard, the ratio of the moles of repeating unit (V) to the moles of repeating unit (VI) may typically be controlled within a certain range. For instance, the ratio may be 0.001 or more, such as 0.01 or more, such as 0.05 or more, such as 0.1 or more, such as 0.2 or more, such as 0.5 or more, such as 0.6 or more, such as 0.8 or more to 10 or less, such as 8 or less, such as 5 or less, such as 4 or less, such as 3 or less, such as 2.5 or less, such as 2 or less, such as 1.7 or less, such as 1.5 or less, such as 1.4 or less, such as 1.2 or less, such as 1 or less.

The number average molecular weight of the repeating unit (V) may be about 300 Daltons or more, such as about 500 Daltons or more, such as about 1,000 Daltons or more, such as about 2,000 Daltons or more, such as about 4,000 Daltons or more. The number average molecular weight of the repeating unit (V) may be about 50,000 Daltons or less, such as about 30,000 Daltons or less, such as 20,000 Daltons or less, such as about 15,000 Daltons or less, such as about 12,000 Daltons or less, such as about 10,000 Daltons or less, such as about 8,000 Daltons or less, such as about 6,000 Daltons or less, such as about 4,000 Daltons or less. The number average molecular weight of the repeating unit (VI) may likewise be about 300 Daltons or more, such as about 500 Daltons or more, such as about 1,000 Daltons or more, such as about 2,000 Daltons or more, such as about 4,000 Daltons or more. The number average molecular weight of the repeating unit (VI) may be about 50,000 Daltons or less, such as about 30,000 Daltons or less, such as 20,000 Daltons or less, such as about 15,000 Daltons or less, such as about 12,000 Daltons or less, such as about 10,000 Daltons or less, such as about 8,000 Daltons or less, such as about 6,000 Daltons or less, such as about 4,000 Daltons or less. The molecular weight may be determined using gel permeation chromatography as generally known in the art.

Furthermore, to help tailor the desired properties of the polymer for the intended functionality, the balance between the content of the repeating units (I) and (IV), as well as their respective molecular weights, may be selectively controlled. For instance, the repeating unit (I) of the polymer may constitute at least 0.01%, such as at least 0.1%, such as at least 0.5%, such as at least 1%, such as at least 2%, such as at least 5%, such as at least 10%, such as at least 15%, such as at least 25%, such as at least 40%, such as at least 50% of the repeating units of the polymer to 98% or less, such as 95% or less, such as 90% or less, such as 80% or less, such as 75% or less, such as 60% or less, such as 50% or less, such as 40% or less, such as 30% or less, such as 20% or less, such as 15% or less, such as 10% or less, such as 8% or less, such as 6% or less of the repeating units of the polymer. Likewise, the repeating unit (IV) of the polymer may constitute at least 0.01%, such as at least 0.1%, such as at least 0.5%, such as at least 1%, such as at least 2%, such as at least 5%, such as at least 10%, such as at least 15%, such as at least 25%, such as at least 30%, such as at least 40%, such as at least 50%, such as at least 60%, such as at least 70%, such as at least 75% of the repeating units of the polymer to 98% or less, such as 96% or less, such as 94% or less, such as 90% or less, such as 85% or less, such as 80% or less, such as 75% or less, such as 65% or less, such as 60% or less, such as 50% or less, such as 40% or less of the repeating units of the polymer.

Accordingly, the number of units of repeating unit (I) in the polymer may be from 1 to 500. For instance, the number of units of repeating unit (I) may be 1 or more, such as 2 or more, such as 3 or more, such as 5 or more, such as 10 or more, such as 20 or more, such as 25 or more, such as 30 or more, such as 40 or more, such as 50 or more, such as 75 or more. In addition, the number of units of repeating unit (I) may be 500 or less, such as 400 or less, such as 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less.

In addition, the number of units of repeating unit (IV) in the polymer be from 1 to 500. In this regard, the number of units of repeating unit (IV) may be 1 or more, such as 2 or more, such as 3 or more, such as 5 or more, such as 10 or more, such as 20 or more, such as 25 or more, such as 30 or more, such as 40 or more, such as 50 or more, such as 75 or more, such as 100 or more, such as 125 or more, such as 150 or more, such as 200 or more. In addition, the number of units of repeating unit (IV) may be 500 or less, such as 400 or less, such as 350 or less, such as 300 or less, such as 250 or less, such as 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less.

In this regard, the ratio of the moles of repeating unit (I) to the moles of repeating unit (IV) may typically be controlled within a certain range. For instance, the ratio may be 0.001 or more, such as 0.01 or more, such as 0.05 or more, such as 0.1 or more, such as 0.2 or more, such as 0.5 or more, such as 0.6 or more, such as 0.8 or more to 10 or less, such as 8 or less, such as 5 or less, such as 4 or less, such as 3 or less, such as 2.5 or less, such as 2 or less, such as 1.7 or less, such as 1.5 or less, such as 1.4 or less, such as 1.2 or less, such as 1 or less.

In addition, the number average molecular weight of the repeating unit (I) may be about 300 Daltons or more, such as about 500 Daltons or more, such as about 1,000 Daltons or more, such as about 2,000 Daltons or more, such as about 4,000 Daltons or more. The number average molecular weight of the repeating unit (I) may be about 50,000 Daltons or less, such as about 40,000 Daltons or less, such as about 25,000 Daltons or less, such as about 20,000 Daltons or less, such as about 15,000 Daltons or less, such as about 12,000 Daltons or less, such as about 10,000 Daltons or less, such as about 8,000 Daltons or less, such as about 6,000 Daltons or less. The number average molecular weight of the repeating unit (IV) may likewise be about 300 Daltons or more, such as about 500 Daltons or more, such as about 1,000 Daltons or more, such as about 2,000 Daltons or more, such as about 4,000 Daltons or more. The number average molecular weight of the repeating unit (IV) may be about 50,000 Daltons or less, such as about 40,000 Daltons or less, such as about 25,000 Daltons or less, such as about 20,000 Daltons or less, such as about 15,000 Daltons or less, such as about 12,000 Daltons or less, such as about 10,000 Daltons or less, such as about 8,000 Daltons or less, such as about 6,000 Daltons or less. The number average molecular weight of the entire polymer may be about 1,000 Daltons or more, such as about 2,000 Daltons or more, such as about 4,000 Daltons or more, such as about 6,000 Daltons or more, such as about 8,000 Daltons or more, such as about 10,000 Daltons or more. The number average molecular weight of the entire polymer may be about 100,000 Daltons or less, such as about 80,000 Daltons or less, such as about 60,000 Daltons or less, such as about 40,000 Daltons or less, such as about 30,000 Daltons or less, such as about 25,000 Daltons or less, such as about 20,000 Daltons or less, such as about 15,000 Daltons or less. The molecular weight may be determined using gel permeation chromatography as generally known in the art.

Of course, it should also be understood that other repeating units or constituents may also be present in the polymer if so desired. For instance, the polymer may contain another repeating unit (V) that is different than the repeating units (I) and/or (IV). When employed, such repeating units may typically constitute no more than about 20 mol. %, such as no more than about 10 mol. %, such as no more than about 5 mol %, such as no more than about 4 mol % to about 0.1 mol % or more, such as about 0.2 mol % or more, such as about 0.5 mol % or more, such as about 0.7 mol % or more, such as about 1 mol % or more, such as about 2 mol % or more of the polymer. In one embodiment, the polymer may not contain any other repeating unit other than repeating units (I) and/or (IV).

The polymer may also possess any desired configuration. For instance, when different types of monomers are employed, the polymer may possess any type of order, such as block (diblock, triblock, tetrablock, etc.), random, alternating, graft, star, etc.

In one embodiment, the polymer may have a relatively highly ordered structure. In this regard, the polymer may have a relatively high crystalline melting temperature, such as about 30° C. or more, such as about 40° C. or more, such as about 50° C. to about 100° C. or less, such as about 80° C. or less, such as about 60° C. or less. The polymer may also have a relatively low crystallization temperature, such as about 50° C. or less, and in some embodiments, from about 10° C. to about 30° C., as well as a low glass transition temperature, such as about 60° C. or less, and in some embodiments, from about 10° C. to about 55° C. The melting temperature, the crystallization temperature, and the glass transition temperature may be determined using differential scanning calorimetry (DSC).

As mentioned herein, certain substituent groups may include an alkyl, an alkenyl, or an alkynyl. It should be understood that these may also include a distribution. For instance, for an alkyl, it may include a distribution of alkyls. In particular, if any of R₁, R₃, R₄, R₅, R₆, R₉, or R₁₀ are an alkyl wherein the alkyl is a C_{q}-Cᵣ alkyl, such alkyl may include other alkyls outside of this range of q to r; however, the average chain length would be from q to r. For example, if the R₁ alkyl is a C₁₄-C₂₄ alkyl, the R₁ group of the polymer may include other alkyls outside of the range of 14 to 24 carbon atoms; however, the average chain length would be between 14 and 24 carbon atoms. Although the R₁ alkyl is expressly mentioned as an example within this paragraph, it should be understood that such also applies to the other alkyls as well as the alkenyls and alkynyls.

The polymer may be formed using any known polymerization technique as is known in the art. For instance, the techniques may be employed to provide a non-cyclic polymer (i.e., a linear polymer). In this regard, the polymer may not be a cyclic polymer. In one embodiment, for example, a phenol monomer may be synthesized. For instance, the phenol monomer may have the following structure:

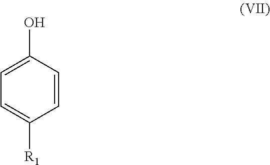

wherein:

R₁ is as defined above.

As an example, when R₁ is an alkyl, suitable monomers may include butylphenol, nonylphenol, tetracosanylphenol, pentacosanylphenol, hexacosanylphenol, heptacosanylphenol, octacosanylphenol, etc., as well as mixtures thereof. However, it should be understood that other alkylphenol monomers may also be utilized.

Also, as indicated above, R₁ may be -A-Y—R₁₀ wherein A, Y, and R₁₀ are as defined above. The phenol monomer utilized in forming such a repeating unit (I) may be formed using various techniques. In particular, the phenol monomer utilized in forming such a repeating unit (I) may be formed by reacting compound (VIII) having the following structure:

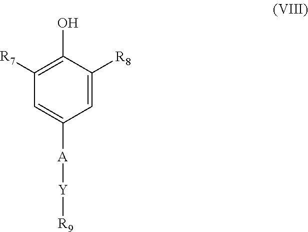

wherein:

A and Y are as defined above;

R₇ and R₈ are each independently hydrogen or a C₁-C₁₀ alkyl; and

R₉ is hydrogen or a C₁-C₅ alkyl.

In particular, the phenol monomer for forming such a repeating unit (I) wherein R₁ is -A-Y—R₁₀ may be formed by reacting the aforementioned compound (VIII) with a compound (IX) having a hydroxyl moiety.

As indicated above, R₇ and R₈ are each independently hydrogen or a C₁-C₁₀ alkyl. In one embodiment, R₇ and R₈ may be different. In another embodiment, however, R₇ and R₈ may be the same.

In one embodiment, at least one of R₇ and R₈ may be hydrogen. For instance, in one embodiment, R₇ may be hydrogen. In another embodiment, R₈ may be hydrogen. In a further embodiment, R₇ and R₈ may be hydrogen. In a further embodiment, at least one of R₇ and R₈ may be a C₁-C₁₀ alkyl. For instance, in one embodiment, R₇ may be a C₁-C₁₀ alkyl. In another embodiment, R₈ may be a C₁-C₁₀ alkyl. In a further embodiment, R⁷ and R₈ may be a C₁-C₁₀ alkyl. In particular, the alkyl may be a C₁-C₇ alkyl, such as a C₁-C₆ alkyl, such as a C₁-C₅ alkyl, such as a C₁-C₄ alkyl, such as a C₂-C₄ alkyl, C₃-C₄ alkyl, such as a C₁-C₃ alkyl. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), etc. In one particular embodiment, the alkyl may be butyl, such as tert-butyl.

As indicated above, R₉ is hydrogen or a C₁-C₅ alkyl. In one embodiment, R₉ is hydrogen. In another embodiment, R₉ is a C₁-C₅ alkyl. For instance, the alkyl may be a C₁-C₅ alkyl, such as a C₁-C₄ alkyl, such as a C₁-C₃ alkyl, such as a C₁-C₂ alkyl, such as a C₁ alkyl. In one particular embodiment, the alkyl is a straight chain alkyl.

As indicated above, the monomer for repeating unit (I) wherein R₁ is -A-Y—R₁₀ may be formed by reacting the aforementioned compound (VIII) with a compound (IX) having a hydroxyl moiety. In particular, compound (IX) may be a hydroxyl-substituted C₁-C₈₀ alkyl, a hydroxyl-substituted C₂-C₂₀ alkenyl, a hydroxyl-substituted C₂-C₂₀ alkynyl, a hydroxyl- substituted C₃-C₁₂ aryl, or a hydroxyl-terminated polyether.

In one embodiment, compound (IX) may be a hydroxyl-substituted C₁-C₈₀ alkyl. In another embodiment, compound (IX) may be a hydroxyl-substituted C₂-C₂₀ alkenyl. In a further embodiment, compound (IX) may be a hydroxyl-substituted C₂-C₂₀ alkynyl. In an even further embodiment, compound (IX) may be a hydroxyl-substituted C₃-C₁₂ aryl. In another embodiment, compound (IX) may be a hydroxyl-terminated polyether.

As indicated above, in one embodiment, compound (IX) may be a hydroxyl-substituted C₁-C₈₀ alkyl. In this regard, the alkyl may be a C₁-C₈₀ alkyl, such as a C₃-C₈₀ alkyl, such as a C₄-C₇₀ alkyl, such as a C₅-C₆₀ alkyl, such as a C₆-C₅₀ alkyl, such as a C₈-C₄₀ alkyl, such as a C₁₀-C₃₀ alkyl, such as a C₁₂-C₂₆ alkyl, such as a C₁₄-C₂₄ alkyl, such as a C₁₆₋₀₂2 alkyl. In addition, the alkyl may be a C₁-C₈₀ alkyl, such as a C₁₀-C₈₀ alkyl, such as a C₂₀-C₈₀ alkyl, such as a C₃₀-C₈₀ alkyl. For instance, the alkyl may have 1 or more, such as 2 or more, such as 3 or more, such as 4 or more, such as 5 or more, such as 6 or more, such as 8 or more, such as 10 or more, such as 11 or more, such as 12 or more, such as 14 or more, such as 16 or more, such as 18 or more, such as 20 or more, such as 24 or more carbon atoms. The alkyl may have 80 or less, such as 70 or less, such as 60 or less, such as 50 or less, such as 40 or less, such as 30 or less, such as 26 or less, such as 24 or less, such as 20 or less, such as 18 or less, such as 16 or less, such as 14 or less, such as 12 or less, such as 10 or less, such as 8 or less, such as 6 or less carbon atoms. In addition, the alkyl may be a straight chain, a branched chain, or cyclic. In one embodiment, the alkyl is a straight chain. In another embodiment, the alkyl is a branched chain. In a further embodiment, the alkyl is cyclic.

As indicated above, in one embodiment, the alkyl may be a branched chain alkyl. In this regard, compound (IX) may be a branched, saturated alcohol, such as a Guerbet alcohol. As generally known in the art, Guerbet alcohols are saturated primary alcohols with branching of the carbon chain. In this regard, such alcohols may be described as 2-alkyl-1-alkanols. Without being limited, these alcohols may include, but are not limited to, 2-butyl hexanol, 2-butyl octanol, 2-butyl decanol, 2-butyl dodecanol, 2-butyl tetradecanol, 2-butyl hexadecanol, 2-butyl octadecanol, 2-hexyl hexanol, 2-hexyl octanol, 2-hexyl decanol, 2-hexyl dodecanol, 2-hexyl tetradecanol, 2-hexyl hexadecanol, 2-hexyl octadecanol, 2-octyl hexanol, 2-octyl octanol, 2-octyl decanol, 2-octyl dodecanol, 2-octyl tetradecanol, 2-octyl hexadecanol, 2-octyl octadecanol, 2-decyl hexanol, 2-decyl octanol, 2-decyl decanol, 2-decyl dodecanol, 2-decyl tetradecanol, 2-decyl hexadecanol, 2-decyl octadecanol, 2-dodecyl hexanol, 2-dodecyl octanol, 2-dodecyl decanol, 2-dodecyl dodecanol, 2-dodecyl tetradecanol, 2-dodecyl hexadecanol, 2-dodecyl octadecanol, 2-tetradecyl hexanol, 2-tetradecyl octanol, 2-tetradecyl decanol, 2-tetradecyl dodecanol, 2-tetradecyl tetradecanol, 2-tetradecyl hexadecanol, and 2-tetradecyl octadecanol.

As indicated above, in one embodiment, compound (IX) may be a hydroxyl-substituted C₂-C₂₀ alkenyl. In this regard, the alkenyl may be a C₂-C₂₀ alkenyl, such as a C₄-C₂₀ alkenyl, such as a C₆-C₂₀ alkenyl, such as a C₁₀-C₂₀ alkenyl, such as a C₁₂-C₂₀ alkenyl, such as a C₁₄-C₂₀ alkenyl, such as a C₁₄-C₁₈ alkenyl. For instance, the alkenyl may have 2 or more, such as 3 or more, such as 4 or more, such as 5 or more, such as 6 or more, such as 8 or more, such as 10 or more, such as 12 or more, such as 14 or more, such as 16 or more carbon atoms. The alkenyl may have 20 or less, such as 18 or less, such as 16 or less carbon atoms, such as 14 or less, such as 12 or less, such as 10 or less, such as 8 or less, such as 6 or less carbon atoms. In addition, the alkenyl may be a straight chain or a branched chain. In one embodiment, the alkenyl is a straight chain. In another embodiment, the alkenyl is a branched chain.

As indicated above, in one embodiment, compound (IX) may be a hydroxyl-substituted C₂-C₂₀ alkynyl. In this regard, the alkynyl may be a C₂-C₂₀ alkynyl, such as a C₄-C₂₀ alkynyl, such as a C₆-C₂₀ alkynyl, such as a C₁₀-C₂₀ alkynyl, such as a C₁₂-C₂₀ alkynyl, such as a C₁₄-C₂₀ alkynyl, such as a C₁₄-C₁₈ alkynyl. For instance, the alkynyl may have 2 or more, such as 3 or more, such as 4 or more, such as 5 or more, such as 6 or more, such as 8 or more, such as 10 or more, such as 12 or more, such as 14 or more, such as 16 or more carbon atoms. The alkynyl may have 20 or less, such as 18 or less, such as 16 or less carbon atoms, such as 14 or less, such as 12 or less, such as 10 or less, such as 8 or less, such as 6 or less carbon atoms. In addition, the alkynyl may be a straight chain or a branched chain. In one embodiment, the alkynyl is a straight chain. In another embodiment, the alkynyl is a branched chain.

As indicated above, in one embodiment, compound (IX) may be a hydroxyl-substituted C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems.

As indicated above, in one embodiment, compound (IX) may be a hydroxyl-terminated polyether. As generally known in the art, such polyethers are compounds having at least one ether group. In this regard, the polyether may be a C₂ polyether, a C₃ polyether, or a C₄ polyether. For instance, in one embodiment, the polyether may generally be a polyalkylene glycol. In one embodiment, the polyalkylene glycol may be a polyethylene glycol. In another embodiment, the polyalkylene glycol may be a polypropylene glycol. In an even further embodiment, the polyalkylene glycol may be a polytetramethylene glycol. In particular, the polyether may be a monoalkyl polyalkylene glycol. These may include a monomethyl polyethylene glycol to provide a polyethylene glycol, a monomethyl polypropylene glycol to provide a polypropylene glycol, or a monomethyl polytetramethylene glycol to provide a polytetramethylene glycol.

The polyether may have a weight average molecular weight of 200 g/mol or more, such as 300 g/mol or more, such as 400 g/mol or more, such as 500 g/mol, such as 750 g/mol or more, such as 1,000 g/mol or more to 10,000 g/mol or less, such as 7,500 g/mol or less, such as 5,000 g/mol or less, such as 4,000 g/mol or less, such as 3,000 g/mol or less, such as 2,500 g/mol or less, such as 2,000 g/mol or less, such as 1,500 g/mol or less, such as 1,250 g/mol or less, such as 1,000 g/mol or less.

In general, compound (VIII) may be a substituted dialkylphenol, for example wherein the substitution is at the position ortho to the hydroxyl group. In particular, compound (VIII) may be a substituted di-tert-butylphenol, such as a substituted 2,6-di-tert-butylphenol. Furthermore, compound (VIII) may undergo a dealkylation/deprotection step and a transesterification for producing the phenol monomer utilized in forming repeating unit (I) wherein R₁ is -A-Y—R₁₀. To form the phenol monomer, compound (VIII) may be first deprotected and then undergo transesterification, or alternatively compound (VIII) may first undergo transesterification and then be deprotected.

Such deprotection and transesterification reactions may be conducted according to conditions generally employed in the art. For instance, the deprotection reaction may be conducted in a liquid phase. The liquid may be an organic liquid and is not necessarily limited by the present invention. For instance, the liquid may be xylenes. The deprotection reaction may also be conducted in the presence of an acid, such as a strong organic acid. As an example, the acid may include a sulfonic acid, such as a toluenesulfonic acid. The deprotection reaction may be conducted at a temperature greater than room temperature, such as 25° C. or more, such as 50° C. or more, such as 75° C. or more, such as 100° C. or more, such as 125° C. or more, such as 140° C. or more. The reaction may also be conducted in the presence of an inert gas, such as argon and/or nitrogen.

The transesterification reaction may be conducted under basic conditions. For instance, a base may be added to the reaction mixture including compound (VIII) and compound (IX). In particular, the base may be a strong base. The base may be potassium hydroxide, sodium hydroxide, lithium hydroxide, or a combination thereof. The addition of such base may be at a temperature greater than room temperature, such as 25° C. or more, such as 40° C. or more, such as 50° C. or more, such as 60° C. or more, such as 70° C. or more. Upon adding the base, the transesterification reaction may be conducted at a temperature greater than room temperature, such as 25° C. or more, such as 50° C. or more, such as 75° C. or more, such as 100° C. or more, such as 125° C. or more, such as 150° C. or more. The transesterification reaction may be conducted under vacuum.

Such deprotection and transesterification reactions may yield compound (X) having the following structure:

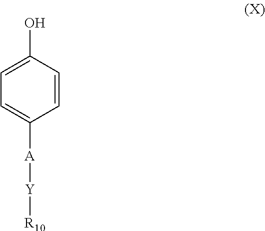

wherein:

A, Y, and R₁₀ are as defined above.

While the aforementioned may describe a manner for forming the phenol monomer utilized in forming repeating unit (I) wherein R₁ is -A-Y—R₁₀, it should be understood that other methods generally known in the art may also be utilized for forming such phenol monomer utilized in forming repeating unit (I) wherein R₁ is -A-Y—R₁₀.

Regardless of the phenol monomers utilized, the monomers used to form the polymer can be reacted with a formaldehyde source in the presence of a catalyst. Suitable formaldehyde sources may include, for instance, formaldehyde (HCHO), paraform, trioxane, alkylaldehyde, etc. The ratio of the total number of moles of the formaldehyde source to the total number of moles of the monomers may be about 0.01 or more, such as about 0.1 or more, such as about 0.2 or more, such as about 0.3 or more, such as about 0.5 or more, such as about 0.6 or more, such as about 0.8 or more, such as 0.9 or more to about 3 or less, such as about 2 or less, such as about 1.5 or less, such as about 1.2 or less, such as about 1.1 or less, such as about 1.05 or less, such as about 1.0 or less, such as about 0.95 or less, such as about 0.9 or less, such as about 0.8 or less.

A base or acid catalyst may be employed. Examples of suitable base catalysts include sodium hydroxide, barium hydroxide, potassium hydroxide, calcium hydroxide, organic amines, sodium carbonate, and combinations thereof. Examples of suitable acid catalysts include hydrochloric acid, sulfuric acid, phosphoric acid, sulfonic acid, sulfamido acids, haloacetic acids, and combinations thereof. In particular embodiments, a sulfonic acid catalyst (e.g., p-toluene sulfonic acid or dodecylbenzenesulfonic acid) is employed. The reaction may occur at an elevated temperature, such as a temperature of from about 50° C. to about 180° C., and in some embodiments, from about 80° C. to about 120° C.

Once the monomers are polymerized, a polymer precursor will be formed. The polymer precursor may be a non-cyclic polymer (i.e., a linear polymer). In this regard, the polymer may not be a cyclic polymer. The polymer precursor may have the following repeating unit (IV):

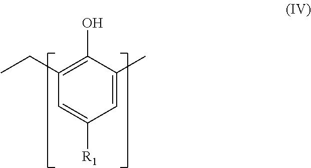

wherein

R₁ is as defined above.

Once formed, the polymer precursor may be reacted to remove at least some of the hydrogen present within the hydroxyl group of the monomers. For instance, in one embodiment, the polymer precursor may be reacted with a compound including a glycidyl group. In particular, the glycidyl group of such compound will react with at least some of the hydroxyl groups of the polymer precursor. Such reaction will generally require a ring opening reaction of the glycidyl group of such compound. Such compound may have at least one glycidyl group. In one embodiment, however, such compound may only have one glycidyl group.

The compound including a glycidyl group is not necessarily limited and may be compounds generally known in the art. For instance, such compound may include a glycidyl ether, a glycidyl ester, a glycidyl amine, a glycidyl amide, or a mixture thereof. In one embodiment, such compound may include a glycidyl ether, a glycidyl ester, or a mixture thereof. For instance, in one embodiment, the compound may include a glycidyl ether. In another embodiment, such compound may include a glycidyl ester. In a further embodiment, such compound may include a glycidyl amine. In another embodiment, such compound may include a glycidyl amide.

In one particular embodiment, such compound including a glycidyl group may include a glycidyl ether. For instance, the glycidyl ether may be an alkyl glycidyl ether. The alkyl of such glycidyl ether may be a C₁-C₄₀ alkyl. In this regard, the alkyl may be a C₁-C₄₀ alkyl, such as a C₁-C₃₀ alkyl, such as a C₁-C₂₀ alkyl, such as a C₁-C₁₄ alkyl, such as a C₁-C₁₀ alkyl, such as a C₂-C₈ alkyl, such as a C₂-C₆ alkyl. For instance, the alkyl may have 1 or more, such as 2 or more, such as 3 or more, such as 4 or more, such as 5 or more, such as 6 or more, such as 8 or more, such as 10 or more, such as 11 or more, such as 12 or more carbon atoms. The alkyl may have 40 or less, such as 30 or less, such as 20 or less, such as 15 or less, such as 14 or less, such as 12 or less, such as 10 or less, such as 8 or less, such as 6 or less, such as 4 or less carbon atoms. In addition, the alkyl may be a straight chain, a branched chain, or cyclic. In one embodiment, the alkyl is a straight chain. In another embodiment, the alkyl is a branched chain. In a further embodiment, the alkyl is cyclic.

The glycidyl ether is not necessarily limited and may include an aliphatic glycidyl ether, an aromatic glycidyl ether, or a mixture thereof. In one embodiment, the glycidyl ether may be an aromatic glycidyl ether. In another embodiment, the glycidyl ether may be an aliphatic glycidyl ether. The aliphatic glycidyl ether may be a saturated aliphatic glycidyl ether, an unsaturated aliphatic glycidyl ether, or a mixture thereof. In one particular embodiment, the aliphatic glycidyl ether may be a saturated aliphatic glycidyl ether.

The glycidyl ether may include, but is not limited to, an allyl glycidyl ether, an ethyl glycidyl ether, a propyl glycidyl ether (e.g., an isopropyl glycidyl ether), a butyl glycidyl ether, a pentyl glycidyl ether, a hexyl glycidyl ether, a heptyl glycidyl ether, an octyl glycidyl ether, a 2-ethylhexyl glycidyl ether, a nonyl glycidyl ether, a decyl glycidyl ether, a dodecyl glycidyl ether, a tetradecyl glycidyl ether, a hexadecyl glycidyl ether, a phenyl glycidyl ether, a benzyl glycidyl ether, a napthyl glycidyl ether, a 4-nonylphenyl glycidyl ether, a 2-methylpentyl glycidyl ether, a 2-biphenylyl glycidyl ether, a 2-methylphenyl glycidyl ether, or a mixture thereof. In one embodiment, the glycidyl ether may be a butyl glycidyl ether, such as iso-butyl glycidyl ether, a tert-butyl glycidyl ether, an n-butyl glycidyl ether, or a mixture thereof. In one particular embodiment, the glycidyl ether may be n-butyl glycidyl ether.

In one embodiment, such compound including a glycidyl group may include a glycidyl ester. For instance, the glycidyl ester may be an aliphatic glycidyl ester, an aromatic glycidyl ester, or a mixture thereof. In one embodiment, the glycidyl ester may be an aromatic glycidyl ester. In another embodiment, the glycidyl ester may be an aliphatic glycidyl ester. Also, such aliphatic group may be saturated or unsaturated. In one embodiment, such group may be saturated. In another embodiment, such group may be unsaturated. Also, such aliphatic group may be a straight chain or a branched chain. In one embodiment, such group may be a straight chain. In another embodiment, such group may be a branched chain.

The glycidyl ester may be of a carboxylic acid. Like the aliphatic group, such carboxylic acids may be straight chain or branched. The carboxylic acid may have 1 or more, such as 2 or more, such as 3 or more, such as 5 or more, such as 8 or more, such as 10 or more, such as 14 or more, such as 18 or more, such as 20 or more, such as 24 or more, such as 30 or more carbon atoms. The carboxylic acid may have 50 or less, such as 46 or less, such as 42 or less, such as 40 or less, such as 38 or less, such as 34 or less, such as 30 or less, such as 26 or less, such as 22 or less, such as 18 or less, such as 14 or less, such as 12 or less, such as 10 or less carbon atoms.

In one embodiment, the carboxylic acid may be a fatty acid such that the glycidyl ester is a fatty acid glycidyl ester. For example, such fatty acid may have 12 or more, such as 14 or more, such as 16 or more, such as 18 or more, such as 20 or more, such as 22 or more, such as 24 or more, such as 26 or more, such as 30 or more carbon atoms. The fatty acid may have 48 or less, such as 44 or less, such as 40 or less, such as 36 or less, such as 32 or less, such as 30 or less, such as 28 or less, such as 26 or less, such as 24 or less carbon atoms.

The carboxylic acids may include, but are not limited to, a methanoic acid, an ethanoic acid, a propionic acid, a butanoic acid, a pentanoic acid, a hexanoic acid, a heptanoic acid, an octanoic acid, a nonanoic acid, a decanoic acid (e.g., neodecanoic acid), an undecanoic acid, a dodecanoic acid, a tridecanoic acid, a tetradecanoic acid, a pentadecanoic acid, a hexadecanoic acid, a heptadecanoic acid, an octadecanoic acid, a nonadecanoic acid, an icosanoic acid, and mixtures thereof. However, it should be understood that even longer chain carboxylic acids may be utilized. In addition, aromatic carboxylic acids may also be utilized.

Regardless of such compound, the compound including a glycidyl group may be reacted with the phenol polymer in a certain amount. For instance, the compound may be reacted in an amount of from 0.05 to 1.0 molar equivalents (meq) based on the moles of hydroxyl groups (or repeating units). For instance, the amount may be 0.05 or more, such as 0.1 or more, such as 0.2 or more, such as 0.3 or more, such as 0.4 or more, such as 0.5 or more. The molar equivalents may be 1.0 or less, such as 0.9 or less, such as 0.8 or less, such as 0.7 or less, such as 0.6 or less, such as 0.5 or less, such as 0.4 or less, such as 0.3 or less.

Similarly, in the reaction, the compound including a glycidyl group may be provided in an amount of 0.0001 wt. % or more, such as 0.001 wt. % or more, such as 0.01 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 10 wt. % or more, such as 15 wt. % or more relative to the weight of the phenol polymer. The compound including a glycidyl group may be provided in an amount of 50 wt. % or less, such as 40 wt. % or less, such as 30 wt. % or less, such as 20 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1 wt. % or less relative to the weight of the phenol polymer.

Accordingly, at least 0.001%, such as at least 0.01%, such as at least 0.1%, such as at least 0.2%, such as at least 0.5%, such as at least 1%, such as at least 2%, such as at least 3%, such as at least 5%, such as at least 10%, such as at least 15%, such as at least 20%, such as at least 25%, such as at least 40%, such as at least 50% of the hydroxyl groups may be modified or reacted. In addition, 100% or less, such as 90% or less, such as 80% or less, such as 70% or less, such as 50% or less, such as 40% or less, such as 30% or less, such as 20% or less, such as 10% or less, such as 5% or less, such as 4% or less of the hydroxyl groups may be modified or reacted. In one embodiment, 100% of the hydroxyl groups may be modified.

Such reaction between the phenol polymer and the compound including a glycidyl group may be conducted according to conditions allowing for reaction between the hydroxyl group (i.e., the one bonded to the aromatic ring of the repeating unit) and the glycidyl group of the compound. For instance, such reaction may be allowed to occur for 0.1 hours or more, such as 0.2 hours or more, such as 0.3 hours or more, such as 0.5 hours or more, such as 1 hour or more, such as 1.2 hours or more, such as 1.5 hours or more, such as 2 hours or more to 10 hours or less, such as 8 hours or less, such as 6 hours or less, such as 4 hours of less, such as 3 hours or less, such as 2.5 hours of less, such as 2 hours of less, such as 1.8 hours or less, such as 1.6 hours or less, such as 1.5 hours or less, such as 1.3 hours or less, such as 1 hour or less. Also, the reaction temperature may be greater than room temperature, such as 25° C. or more, such as 50° C. or more, such as 75° C. or more, such as 100° C. or more, such as 125° C. or more, such as 140° C. or more. The reaction may also be conducted in the presence of reagents that may promote the reaction. For instance, a catalyst may be employed in the reaction. The catalyst may include, but is not limited to, an imidazole. The imidazole may be 2-methylimidazole, 2-benzyl-2-methylimidazole, etc.

Once formed, the polymer can be utilized for various applications. For example, the polymer may be utilized in a compound, such as a petroleum composition and/or a paraffin inhibitor composition. In one embodiment, the polymer may be employed in a petroleum composition with a petroleum source. In this regard, the present disclosure may also include a method of modifying a petroleum source by adding the polymer to the petroleum source. Regardless, the polymer may be employed at a concentration of 1 ppm or more, such as 2 ppm or more, such as 5 ppm or more, such as 10 ppm or more, such as 25 ppm or more, such as 50 ppm or more, such as 100 ppm or more, such as 250 ppm or more, such as 500 ppm or more, such as 1,000 ppm or more, such as 2,000 ppm or more, such as 2,500 ppm or more, such as 3,000 ppm or more, such as 5,000 ppm or more to 10,000 ppm or less, such as 9,000 ppm or less, such as 7,500 ppm or less, such as 6,000 ppm or less, such as 5,000 ppm or less, such as 3,000 ppm or less, such as 2,500 ppm or less, such as 2,000 ppm or less, such as 1,500 ppm or less, such as 1,200 ppm or less, such as 1,000 ppm or less, such as 500 ppm or less based on the combined weight of the polymer and the petroleum source. The petroleum source may be a source of crude oil, another unrefined petroleum source, or a product derived therefrom, such as heating oil, fuel oil, bunker C oil, bitumen, etc.

The particular manner in which the polymer is added to a petroleum source may vary. If desired, the polymer may be employed in the form of a concentrated composition that contains the polymer as the primary ingredient. In other embodiments, the polymer may be employed in a composition that is in the form of a dispersion or solution that contains one or more solvents in combination with the polymer. Dilution may occur prior to use, or it may also occur in the field by an end user of the composition.

When employing the polymer in a composition, suitable solvents may include organic solvents, such as aliphatic and/or aromatic hydrocarbons. Particularly suitable solvents include, for instance, petroleum-based solvents that include refined petroleum distillates or solvents. Refined petroleum distillates or solvents may include, for instance, aromatic compounds, such as benzene, toluene, xylene, light aromatic naphtha, heavy aromatic naphtha (HAN), kerosene, etc.; aliphatic compounds, such as pentane, hexane, heptane, octane, nonane, decane, undecane, dodecane, tridecane, tetradecane, pentadecane, hexadecane, etc.; as well as mixtures thereof. Naphtha is a petrochemical industry term describing boiling point fractions of petroleum distillate collected at different points on a distillation column. Naphtha fractions may include linear or branched or cyclic alkanes or alkenes, aromatic hydrocarbons, or fused ring aromatic compounds or mixtures of these materials. Light naphtha is a lower boiling material that is collected near the top portion of the distillation column. Medium naphtha is a higher boiling material that is collected from near the middle of the column. Finally, heavy naphtha is an even higher boiling material that is collected from near the bottom portion of the column. When solvents are employed, they typically constitute 20 wt. % or more, such as 30 wt. % or more, such as 40 wt. % or more, such as 50 wt. % or more, such as 60 wt. % or more to 99 wt. % or less, such as 95 wt. % or less, such as 90 wt. % or less, such as 80 wt. % or less of the composition. Likewise, polymer(s), such as described herein, may constitute 0.5 wt. % or more, such as 1 wt. % or more, such as 2 wt. % or more, such as 5 wt. % or more, such as 10 wt. % or more to 80 wt. % or less, such as 70 wt. % or less, such as 50 wt. % or less, such as 40 wt. % or less of the composition.

In addition to a polymer and solvent, the composition may also contain one or more additional ingredients as is known in the art. These ingredients may include corrosion inhibitors, surfactants, neutralizers, stabilizers, plasticizers, biocides, preservatives, etc. Suitable corrosion inhibitors may include, for instance, sulfonates, imidazolines, amines, amides, esters, as well as salts and/or polymers thereof. Examples of amine corrosion inhibitors may include n-tetradecyl amine, n-hexadecylamine, lauryl amine, myristyl amine, palmityl amine, stearyl amine, and oleyl amine, etc. When employed, an additional ingredient may be combined with the polymer at any point after it is formed. For instance, an additional ingredient may be combined with the polymer after it is diluted with a solvent or it may be simultaneously added as the polymer is being formed. Likewise, the additional ingredients may be added at a single point in time or combined with the polymer in the field to form the composition, such as in response to a certain environmental condition. As an example, one or more additional ingredients may be combined with the polymer just prior to transportation or storage, or even just prior to the addition of the polymer to crude oil.

One example of a suitable additional ingredient is a surfactant, which may be employed in an amount of from about 0.1 wt. % to about 10 wt. %, and in some embodiments, from about 0.2 wt. % to about 1 wt. % of the composition. Suitable surfactants may include nonionic surfactants, amphoteric surfactants, and/or anionic surfactants. Examples of suitable nonionic surfactants may include, for instance, alkoxylated alcohols, such as copolymers of ethylene oxide and/or propylene oxide and/or butylene oxide and epoxylated, propoxylated, and epoxylated-propoxylated compounds formed from C₆-C₄₀ alkanols. Other nonionic surfactants may also be employed, such as alkylphenol alkoxylates (e.g., nonylphenol ethoxylate), block copolymers of ethylene, propylene and butylene oxides, alkyl polyglucosides, polyalkoxylated glycerides, sorbitan esters and polyalkoxylated sorbitan esters, and alkoyl polyethylene glycol esters and diesters. Examples of suitable amphoteric surfactants may include alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, betaines, sultaines, alkyl amphoacetates and amphodiacetates, alkyl amphopropionates and amphodipropionates, dodecylbenzene sulfonic acid, and alkyliminodipropionate. Likewise, examples of suitable anionic surfactants may include alkylbenzene sulfonates, alkyldiphenoxyether sulfonates and disulfonates, napthalene sulfonates, linear and branched alkyl sulfonates, fatty alcohol sulfates, fatty alcohol ether sulfates, linear and branched alpha olefin sulfonates.

Neutralizers may also be employed in the composition if desired. For example, unreacted formaldehyde and/or unused acid catalysts (e.g., dodecylbenzenesulfonic acid) can sometimes remain present within the composition. Unreacted formaldehyde can potentially act as a crosslinking agent that causes unwanted solidification at low temperatures, while unused acid catalysts potentially precipitate as seed crystals at low temperatures. Thus, a base compound may be added to neutralize these components, such as a compound that contains one or more amine moieties (e.g., alkyl amine). Suitable alkyl amines may include monoamines (e.g., methyl amine), diamines (e.g., ethylenediamine), triamines (e.g., diethylenetriamine), etc. When employed, the neutralizer may be added in an amount of from about 0.01 wt. % to about 1 wt. %, and in some embodiments, from about 0.05 wt. % to about 0.5 wt. % of the composition.

When employed, the composition containing the polymer, solvent(s), and other optional components may be combined with a petroleum source in an amount of 1 ppm or more, such as 2 ppm or more, such as 5 ppm or more, such as 10 ppm or more, such as 15 ppm or more, such as 25 ppm or more, such as 50 ppm or more, such as 100 ppm or more, such as 250 ppm or more, such as 500 ppm or more, such as 1,000 ppm or more, such as 2,000 ppm or more, such as 2,500 ppm or more, such as 3,000 ppm or more, such as 5,000 ppm or more to 10,000 ppm or less, such as 9,000 ppm or less, such as 8,000 ppm or less, such as 6,000 ppm or less, such as 5,000 ppm or less, such as 3,000 ppm or less, such as 2,500 ppm or less, such as 2,000 ppm or less, such as 1,800 ppm or less, such as 1,500 ppm or less, such as 1,200 ppm or less, such as 1,000 ppm or less, such as 500 ppm or less based on the combined weight of the petroleum source and the polymer composition. The polymer composition may be added to the petroleum source in a variety of different ways to form a petroleum composition, such as during storage and/or transportation of a petroleum source. For example, the polymer composition may be readily poured or pumped from a storage container or vessel into contact with a petroleum source. The polymer composition can be stored within a container for at least some period of time, removed from the container, and then applied to the petroleum source. The duration of storage may vary from about 1 day to five years, such as about 2 days to 1 year, or about 1 week to 6 months, or about 2 weeks to 4 months, or about 1 to 2 months. The method of applying the polymer composition to the petroleum source is not particularly limited and can be conventionally added by using available equipment, such as pipes, mixers, pumps, tanks, injection ports, etc. In some embodiments, the polymer composition is applied to one or more subterranean hydrocarbon recovery (oil well) locations, such as downhole or on the backside using capillary string, gas lift, slip stream or other methods, at the wellhead, or at any other point downstream of the reservoir. The polymer composition may also be employed in combination with umbilical drilling equipment.

### EXAMPLES

### Test Methods

Differential Scanning Calorimetry (DSC): The following equipment was used for this test:
TA Instruments DSC Q2000 with RCS90 Cooling System
TA Instruments Advantage Software with TA Instrument Explorer for instrument control
TA Instruments Universal Analysis software for data analysis
TA Instruments Tzero DSC pans and lids (aluminum)
TA Instruments Tzero Press
Microbalance

Initially, 8 to 11 mg of the sample (to the nearest 0.01 mg) was weighed into a Tzero aluminum pan so that the sample made good contact with the bottom of the pan. Using forceps, the pan lid was put into place and crimped to seal. The appropriate pre-weighed Tzero reference pan was also identified in the autosampler tray, and the autosampler was programed to load the reference pan along with the sample pan. The sample was then analyzed using the following conditions:
Purge Gas: Nitrogen
Purge Rate: 50 mL/min
Load Temperature: 40° C.
Temperature Profile: hold 3 minutes at 10° C., heat to 150° C. at a rate of 10° C./min, cool to 10° C. at a rate of 40° C./min, and hold 3 minutes at 10° C. (Cycle 1) and then heat again to 150° C. at a rate of 10° C./min (Cycle 2).

Cold Finger Evaluation: Cold finger experiments were run on a Multi-place cold finger (PSL Systemtechnik GmbH, Model CF15) using West Texas Crude Oil.

To determine the experimental temperature conditions for both the bath temperature (Tₒᵢₗ) and the temperature for the finger (T_{f}), the wax appearance temperature (WAT or cloud point) of the untreated oil was measured by differential scanning calorimetry (DSC) as described above. This onset temperature for wax precipitation was used to set Tₒᵢₗ, the bath temperature for heating the fluid in the cup, which was set between 0-8° C. above the WAT, and the finger temperature was set between 10 to 20° C. below Tₒᵢₗ. This differential in temperature between the bath and finger (target a ΔT=15° C. for each experiment) created a temperature gradient between the bulk fluid and the surface of the finger. The specific test conditions for the oil are set forth below in Table 1.

| | WAT | Tₒᵢₗ | T_{f} | ΔT | Avg. Blank | Time |
|---|---|---|---|---|---|---|
| Fluid | (° C.) | (° C.) | (° C.) | (° C.) | deposit (g) | (hrs) |
| West Texas | 15 | 18 | 3 | 15 | 1.58 | 24 |
| Crude Oil | | | | | | |

To determine the final amount of material deposited onto the cold finger, the deposit was carefully removed from the cold finger cylinder and weighed. The experiments were run for a long enough period of time (e.g., greater than 4 hours) to deposit wax for an untreated sample such that the blank deposit was greater than 0.200 grams of wax. Samples were prepared by dosing the desired amount of test sample gravimetrically and mixing them with the required amount of preheated test fluids. The treated samples were conditioned in a temperature controlled oven set at 60-70° C. for a period of at least 4 hours before starting the cold finger experiment. In each experiment, an untreated blank was run concomitantly with the fluids treated with the experimental paraffin inhibitor. Based on the test procedure performed above, the paraffinic wax inhibition or percent reduction for a given test sample may then be determined by subtracting the weight of wax deposited by the test sample from the weight of wax deposited by the untreated blank, and then dividing this calculated difference by the weight of wax deposited by the untreated blank.

Rheological Evaluation: Rheology experiments were performed on a TA Discovery HR-1 stress controlled rheometer using a parallel plate geometry with a 40 mm diameter stainless steel upper plate and a Peltier-cooled bottom plate. To minimize solvent loss during experiments, the solvent trap of the top plate was filled with the same solvent used to dissolve the sample and this trap was used in concert with a solvent trap cover that was placed over a Peltier stage. The Peltier solvent trap was equipped with gas inlet fittings and the geometry was swept with a slow stream of nitrogen to minimize water condensation during experiments performed below room temperature. Two methods were used to assess the flow properties of product formulations in aromatic 150 fluid solutions at a non-volatile residue (“NVR”) concentration of 15%. The no-flow-point (“NFP”) method was used to determine the temperature at which the sample no longer flowed when a controlled stress is applied to the sample while the temperature of the sample is decreased. This test method is described in more detail below.

No Flow Point: To perform this test, the Peltier stage was equilibrated to 40° C., the sample was loaded into a trim gap of 350 μm, and the sample was trimmed at a gap of 300 μm by drawing excess sample into a pipette. The sample was then conditioned by preheating to 80° C., holding for 600 seconds, and then initiating a preconditioning step in which the sample was sheared at a rate of 0.1 s⁻¹ for 150 seconds. The sample was then cooled to either 10° C. or 30° C. and then the oscillation temperature sweep was executed. Measurements were taken at 3° C. temperature steps with a stress of 0.4 Pa and an angular frequency of 0.25 rad/s. The reported value for the rheological no-flow-point was the temperature at which the oscillation displacement reached zero.

Cloud Point (CP) and Pour Point (PP): The following equipment was used for this test:
PhaseTechnology ASL-70Xi Autosampler Analyzer

The Phase Technology ASL-70Xi Autosampler Analyzer system is used to determine the cloud point (ASTM D5773) and pour point (ASTM D5949) of lube oils, fuels, and waxy paraffinic solutions. The cloud point and pour point were determined by following the ASTM methods developed and described for each test.

The cloud point and pour point tests are used to assess the ability of a sample to interact with the paraffinic components of a wax burdened fluid. The performance of any one sample is revealed by the measured depression of the both the cloud point and pour point temperature relative to a blank untreated sample. Furthermore, a dose-response over a range of concentrations can provide additional evidence of the magnitude of the interaction between the sample and the paraffin in solution. Samples were prepared by dosing the desired amount of test sample gravimetrically from 15% NVR stock solutions in A150 and mixing them with the required amount of preheated test fluids. The treated samples were conditioned in a temperature controlled oven set at 60-70° C. for a period of at least 4 hours before starting the cloud point and pour point tests. In each test, an untreated blank was run concomitantly with the test fluids treated with the experimental sample. All samples were compared against the average cloud point and pour point values for the untreated fluid. Based on the test procedure performed above, the cloud point depression (ΔCP) and pour point depression (ΔPP) for a given test sample may then be determined by subtracting the measured value of the test sample from the running average of the untreated blank.

Methanol Compatibility: Samples were prepared by diluting with either toluene, xylene, or A150 to 15, 20, or 25% NVR. The dilution was heated in the 60° C. oven for 1 hour and shaken to ensure homogeneity. The samples were then cooled to room temperature and methanol was added to bring the total sample concentration to 15% NVR for all samples. The loadings of methanol were 0%, 5%, and 10% by weight. The samples were then re-heated to 60° C. for 1 hour and shaken. All samples were cooled at the same time on the benchtop for 24 hours and inspected for phase separation, turbidity, or deposition. If the sample displayed any of the previously mentioned conditions, it received “Fail” rating while all passing samples received a “Pass” rating.

### Example 1

The following example demonstrates the synthesis of a modified phenol polymer as defined herein. In particular, a phenol polymer formed from approximately 75% of long chain (30+ carbons) alkylphenol monomers and 25% para-dodecyl phenol (i.e., Control Polymer 1) was reacted with butyl glycidyl ether in the presence of a 2-methylimidazole catalyst. The reaction occurred at a temperature of approximately 135° C. for 1 to 2 hours. The reaction scheme is presented below:

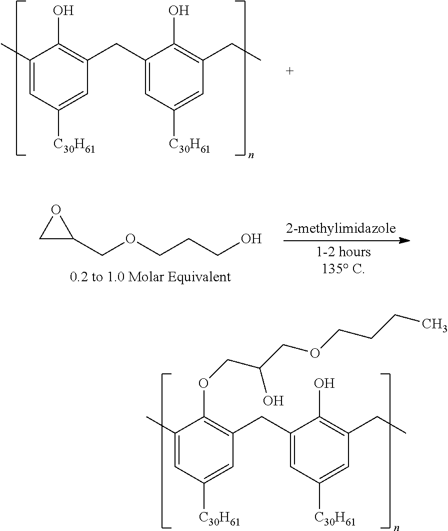

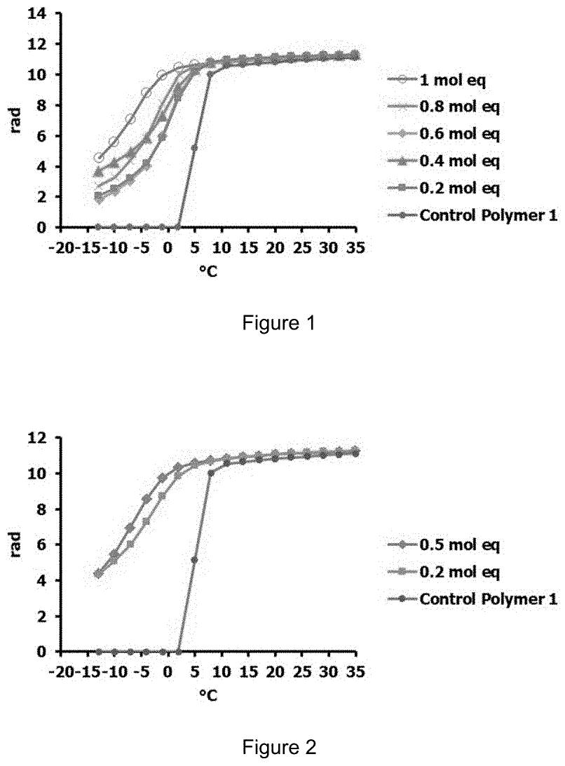

The no flow-point (NFP) at 15% NVR was determined for the unmodified control polymer and the modified polymer. The results are illustrated in FIG. 1. In particular, the results reveal an improvement in the flow properties at low temperatures.

Also, the cloud point and pour point was determined for the unmodified control polymer and the modified polymer.

TABLE 2
Cloud Point and Pour Point Depression

| Product | Cloud Point (° C.) | Pour Point (° C.) |
|---|---|---|
| Control Polymer 1 | 28.1 | 15.0 |
| Example 1 (0.2 mol eq) | 28.2 | 15.0 |
| Example 1 (0.4 mol eq) | 28.2 | 15.0 |
| Example 1 (0.6 mol eq) | 28.3 | 15.0 |
| Example 1 (0.8 mol eq) | 28.3 | 12.0 |
| Example 1 (1.0 mol eq) | 28.3 | 12.0 |

As indicated above, no significant change in performance was observed between the unmodified control polymer and the modified polymer at various molar equivalents of the butyl glycidyl ether.

### Example 2

A phenol polymer formed from approximately 25% of long chain (30+ carbons) alkylphenol monomers and 75% para-dodecyl phenol (i.e., Control Polymer 2) was modified in the same manner as Example 1 to provide another butyl glycidyl ether modified phenol polymer. As illustrated in FIG. 4, the modification showed minimal change in no flow point, which was determined at 15% NVR, at low molar equivalents and some downward trending at the higher molar equivalents. Without intending to be limited by theory, an improvement may not have been realized because Control Polymer 2 generally already exhibits a relatively low no flow point of less than −15° C.

### Example 3

In this example, cold finger testing was conducted at a dosage of 2000 ppm in West Texas Crude. The results are indicated in the table below:

TABLE 3
Cold Finger Testing

| Sample | % Mass Reduction |
|---|---|
| Control Polymer 1 | 71 |
| Control Polymer 2 | 59 |
| Example 1 (0.2 mol eq) | 69 |
| Example 2 (0.2 mol eq) | 72 |
| Example 1 (0.6 mol eq) | 62 |
| Example 2 (0.6 mol eq) | 72 |
| Example 1 (1.0 mol eq) | 67 |
| Example 2 (1.0 mol eq) | 67 |

These results indicate that the performance is sustained by the modification at the various molar equivalents of butyl glycidyl ether. As a result, this may allow the selection of a lesser amount of butyl glycidyl ether to obtain a solubility increase without worry of disrupting the performance of the end use product.

### Example 4

The modified polymer of Example 4 was prepared in a manner similar to that of Example 1 except that a C₁₂-C₁₄ glycidyl ether was reacted with the phenol polymer rather than a butyl glycidyl ether at 0.2 and 0.5 molar equivalents. The no flow point of Control Polymer 1 and the modified polymers of Example 4 at 15% NVR was determined. These results are illustrated in FIG. 2. The results reveal an improvement in the flow properties at low temperatures.

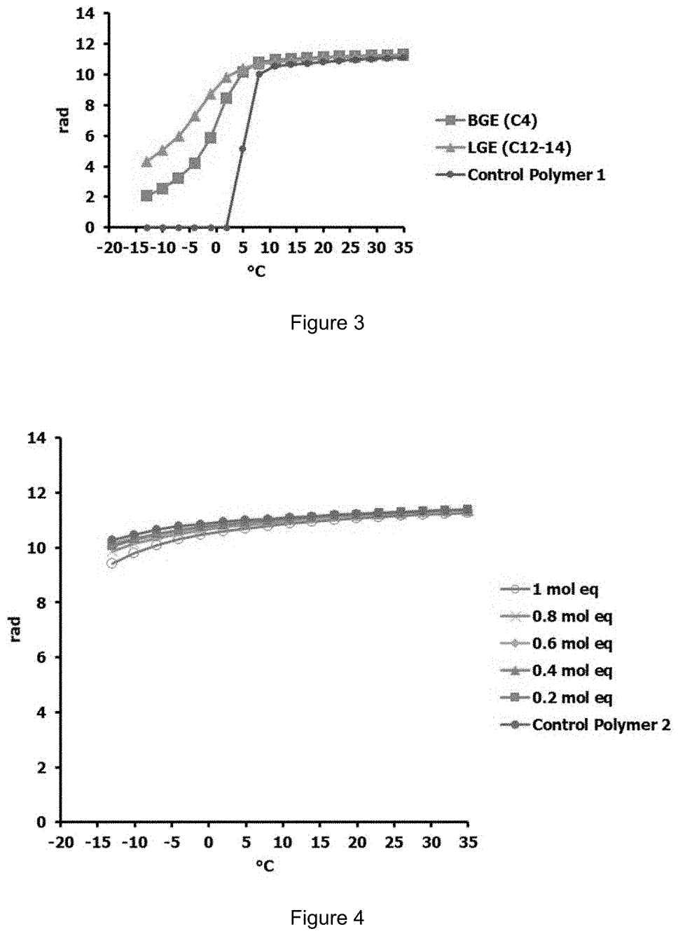

In addition, FIG. 3 illustrates a comparison between the Control Polymer 1 as well as the butyl glycidyl ether modified polymer at 0.2 molar equivalents of Example 1 and the C₁₂-C₁₄ glycidyl ether modified polymer at 0.2 molar equivalents of Example 4. FIG. 3 illustrates that the butyl glycidyl ether modified polymer shows a decrease in the no flow point to at least −13.0° C. with no signs of approaching an oscillatory displacement of 0 radians. Meanwhile, the C₁₂-C₁₄ glycidyl ether modified polymer demonstrates an improvement in the no flow point arriving at −13.0° C. at a higher oscillatory displacement than the butyl glycidyl ether modified polymer.

### Example 5

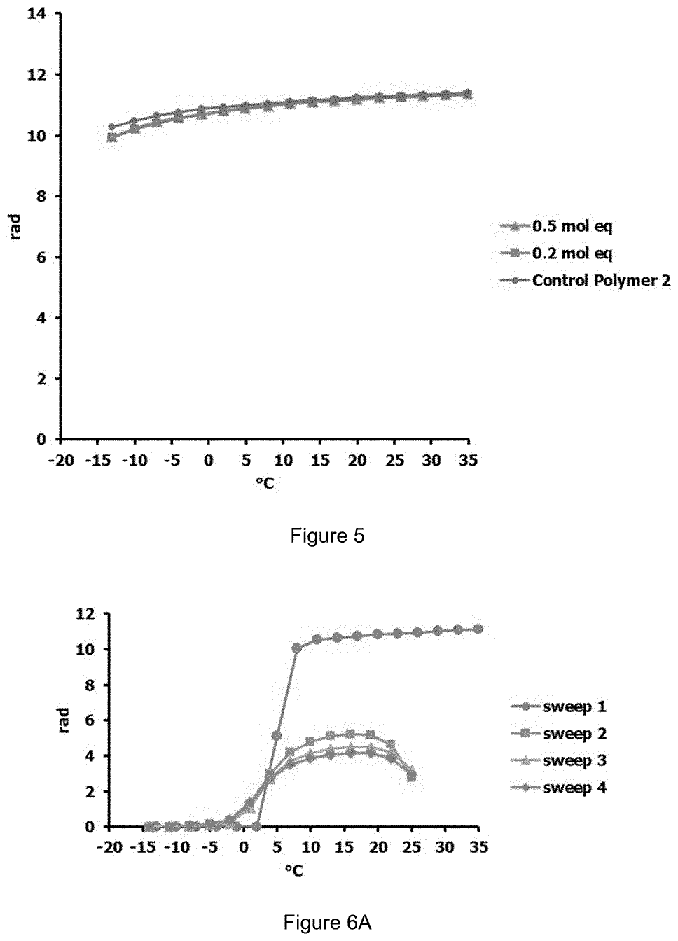

The polymer of Example 5 was prepared in a manner similar to that of Example 2 except that a C₁₂-C₁₄ glycidyl ether was reacted with the phenol polymer rather than a butyl glycidyl ether at 0.2 and 0.5 molar equivalents. The no flow point at 15% NVR was determined for Control Polymer 2 and these modified polymers. These results are illustrated in FIG. 5.

### Example 6

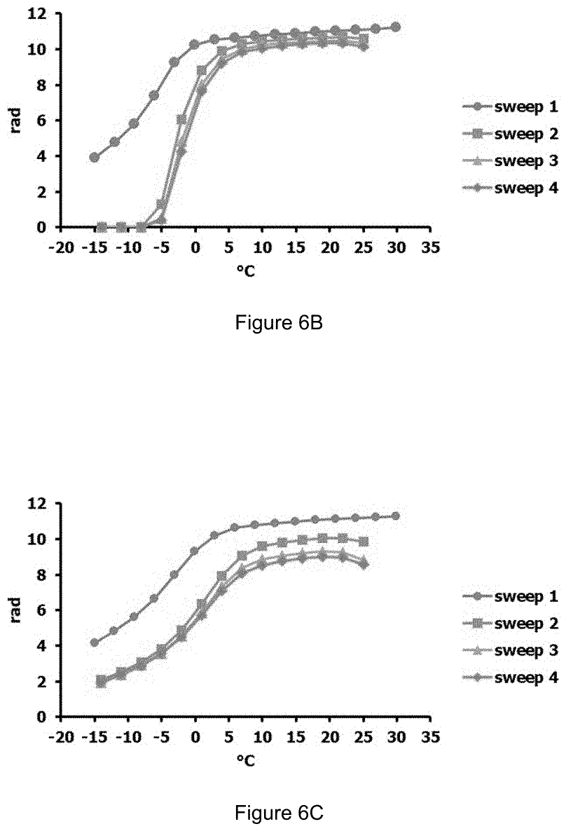

In this example, the effects on hysteresis via thermal cycling were studied using a rheometer. The study was conducted on Control Polymer 1 (FIG. 6A), the butyl glycidyl ether (1.0 molar equivalents) modified polymer of Example 1 (FIG. 6B), and the C₁₂-C₁₄ glycidyl ether (0.5 molar equivalents) modified polymer of Example 4 (FIG. 6C).

The results of FIGS. 6A-C show a significant improvement in the recovery of the product between cycles. For instance, the control polymer shows a generally large hysteresis between the starting condition and subsequent sweeps. This may be due to the subsequent sweeps being conditioned to 25° C., which may not be enough to disentangle any crystallized components. Meanwhile, the butyl glycidyl ether modified polymer appears to become a complete liquid at 25° C. lending the benefit of fully disentangling the polymer and erasing the thermal memory at a lower temperature. This is particularly important in the shelf life of polymers which undergo varied temperatures upon transport and application. In this regard, the butyl glycidyl ether modification can allow for the storage and transport conditions to become less of a concern.

Comparing the modification of the butyl glycidyl ether modified polymer at 1.0 molar equivalents to the C₁₂-C₁₄ glycidyl ether modified polymer at 0.5 molar equivalents generally shows that, at lower concentrations of the C₁₂-C₁₄ glycidyl ether modified polymer, the recovery is generally the same when reheated. But, an improvement in the no flow point after cycling is also observed as seen in FIG. 6C. Generally, longer carbon chains may have a better stabilizing ability.

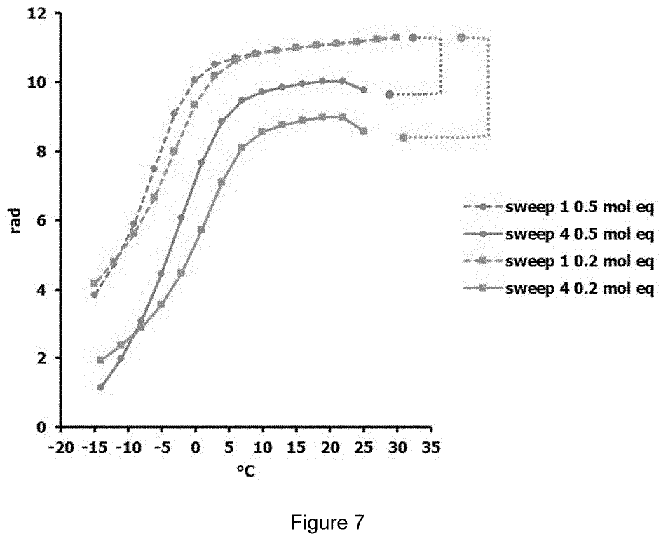

Furthermore, comparing the effect of the concentration of the C₁₂-C₁₄ glycidyl ether modification, as illustrated in FIG. 7, generally shows that higher concentrations have a stabilizing effect on the thermal recovery while still maintaining the no flow point improved performance.

### Example 7

In this example, a glycidyl ester modified polymer was synthesized rather than a glycidyl ether modified polymer. In particular, the modified polymer was synthesized according to the conditions of Example 1 except that a glycidyl ester of neodecanoic acid was substituted for the butyl glycidyl ether.

### Example 8

In this example, the methanol compatibility of the polymers was analyzed. The results are provided in the table below:

| | Toluene | A150 | Xylene |
|---|---|---|---|
| Control polymer 1 (0% MeOH) | Pass | Pass | Fail |
| Example 1 (1.0 meq) (0% MeOH) | Pass | Fail | Pass |
| Example 7 (0.3 meq) (0% MeOH) | Pass | Pass | Pass |
| Control polymer 1 (5% MeOH) | Pass | Fail | Fail |
| Example 1 (1.0 meq) (5% MeOH) | Pass | Fail | Fail |
| Example 7 (0.3 meq) (5% MeOH) | Fail | Fail | Fail |
| Control polymer 1 (10% MeOH) | Fail | Fail | Fail |
| Example 1 (1.0 meq) (10% MeOH) | Pass | Fail | Fail |
| Example 7 (0.3 meq) (10% MeOH) | Fail | Fail | Fail |

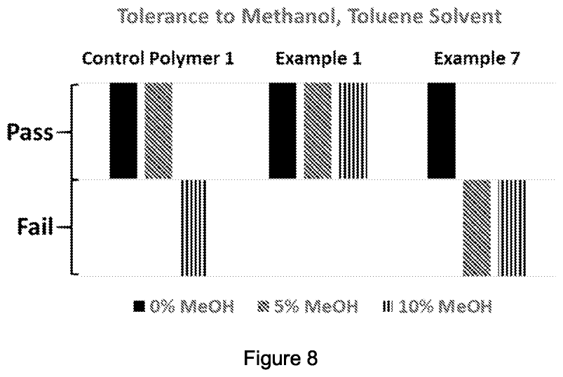

As indicated, toluene had the greatest compatibility with methanol as a solvent. In addition, Example 1 (1.0 meq) showed an unanticipated improvement in methanol compatibility by bringing the solubility of methanol up to 10 weight percent in toluene. FIG. 8 provides a summary of the data presented in the figure above with respect to methanol in toluene.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1-38. (canceled)

39. A polymer having the following repeating unit (I): 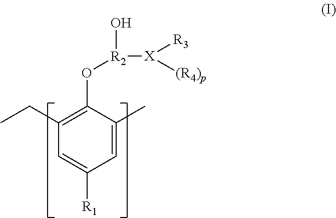
wherein,
R₁ includes an alkyl, an alkenyl, an alkynyl, an aryl, an amine, or -A-Y—R₁₀ wherein
A is a direct bond or an alkylene;
Y is —C(O)O—, —OC(O)—, —C(O)N(R₁₁)—, —N(R₁₁)C(O)—, —C(O)—, —N(R₁₁)—, —O—, or —S—;
R₁₀ includes an alkyl, an alkenyl, an alkynyl, an aryl, or a polyether; and
R₁₁ is H or an alkyl;
R₂ is an alkylene;
X is —O—, —N—, —O—C(O)—, or —N—C(O)—;
R₃ includes an alkyl, an alkenyl, an alkynyl, or an aryl;
R₄ includes H, an alkyl, an alkenyl, an alkynyl, or an aryl; and
p is 0 when X is —O—, —O—C(O)—, or —N—C(O)— and p is 1 when X is —N—.

40. The polymer of claim 39, wherein R₁ is a C₁₆-C₄₀ alkyl.

41. The polymer of claim 39, wherein X is —O— and p is 0.

42. The polymer of claim 39, wherein R₂ is a C₁-C₈ alkylene.

43. The polymer of claim 39, wherein R₃ is a C₁-C₁₀ alkyl.

44. The polymer of claim 39, wherein the number average molecular weight of the polymer is from about 4,000 to about 100,000 Daltons.

45. The polymer of claim 39, wherein the repeating unit (I) comprises a combination of repeating unit (II) and repeating unit (III): 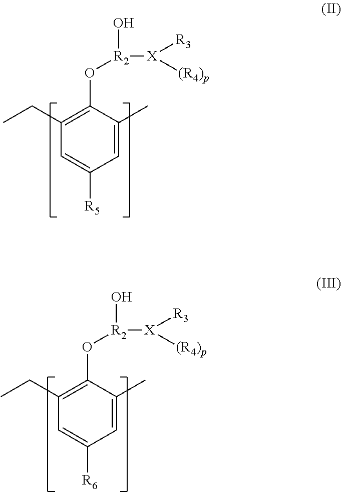
wherein:
R₅ is a C₁-C₁₅ alkyl;
R₆ is a C₂-C₈₀ alkyl, wherein R₅ and R₆ are different; and
R₂, X, R₃, R₄, and p are as defined above.

46. The polymer of claim 45, wherein R₅ is a C₈-C₁₄ alkyl.

47. The polymer of claim 45, wherein R₆ is a C₂₀-C₈₀ alkyl.

48. The polymer of claim 39, wherein the polymer further comprises the following repeating unit (IV): 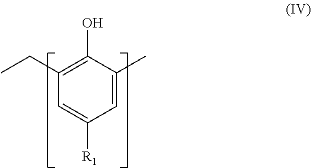
wherein,
R₁ is as defined above.

49. The polymer of claim 48, wherein the repeating unit (IV) comprises a combination of repeating unit (V) and repeating unit (VI): 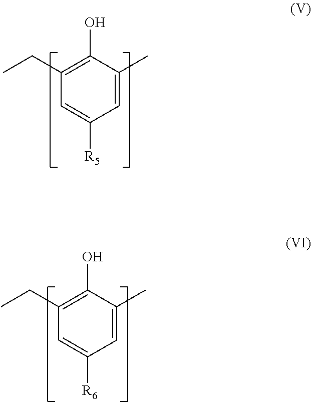
wherein:
R₅ is a C₁-C₁₅ alkyl; and
R₆ is a C₂-C₈₀ alkyl, wherein R₅ and R₆ are different.

50. The polymer of claim 39, wherein the polymer has a pour point depression of greater than or equal to 10° C.

51. The polymer of claim 39, wherein the polymer exhibits a no-flow point of about −10° C. or less as determined at a non-volatile residue concentration of 15%.

52. A method of forming the polymer of claim 39, wherein the method comprises
reacting a phenol polymer with a compound including a glycidyl group.

53. The method of claim 52, wherein the phenol polymer has the following repeating unit (IV): 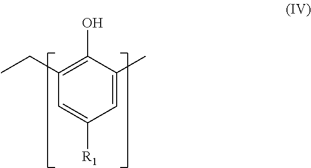
wherein,
R₁ is as defined above.

54. The method of claim 52, wherein the compound including a glycidyl group is a glycidyl ether, a glycidyl ester, a glycidyl amine, or a glycidyl amide.

55. The method of claim 54, wherein the compound including a glycidyl group is a glycidyl ether.

56. The method of claim 55, wherein the glycidyl ether is a C₁-C₂₀ alkyl glycidyl ether.

57. The method of claim 52, wherein the compound including a glycidyl group is present in an amount of 0.05 to 1.0 molar equivalents.

58. The method of claim 52, wherein the phenol polymer is formed by reacting a phenol monomer with a formaldehyde source, wherein the ratio of the total number of moles of the formaldehyde source to the total number of moles of the phenol monomer is from about 0.5 to about 1.1.

59. A paraffin inhibitor composition comprising the polymer of claim 39.

60. A petroleum composition comprising the polymer of claim 39 and a petroleum source.

61. The composition of claim 60, wherein the polymer is present in a concentration of from about 1 to about 10,000 ppm.
